(19) United States
(12) Patent Application Publication
(10) Pub. No.: US 2009/0017436 A1
(43) Pub. Date: Jan. 15, 2009

(54) Integrated instructional management system and method

(76) Inventors: Kenneth A. Sumrall, North Richland Hills, TX (US); Clayton S. Alexander, Arlington, TX (US); Tuan D. Nguyen, North Richland Hills, TX (US); Son M. Pham, Arlington, TX (US); Zehua Chen, Arlington, TX (US); Stanley P. Tigrett, Coppell, TX (US); DeLana K. Tully, Lewisville, TX (US); Rajneesh Gupta, Grapevine, TX (US); Richard O. Ransbottom, Austin, TX (US)

Correspondence Address: DOCKET CLERK, P.O. DRAWER 800889, DALLAS, TX, 75380, US

(21) Appl. No.: 12/074,720

(22) Filed: Mar. 5, 2008

Related U.S. Application Data
(63) Continuation of application No. 11/122,332, filed on May 4, 2005, now abandoned.
Application No. 11/122,332 is a continuation of application No. 09/709,694, filed on Nov. 10, 2000, now abandoned.

(51) Int. Cl. G09B 19/00

(52) U.S. Cl. 434/433

(57) ABSTRACT

A method for generating a lesson plan for a course is provided that includes associating a plurality of standard objectives with the course. A plurality of learning activities are provided for selection. Each learning activity is associated with at least one standard objective for the course. A selection of at least a subset of the learning activities is received. The lesson plan is generated based on the selected learning activities.

### TECHNICAL FIELD OF THE INVENTION

This invention relates generally to the field of educational software and more particularly to an integrated instructional management system and method.

### BACKGROUND OF THE INVENTION

Educating students is an extremely important part of every society. To improve education, a growing trend has been to define objective standards for students at different levels of education. However, simply defining these standards fails to provide a method for implementing an educational system that meets the standards. In addition to this, other problems exist within typical education systems that result in students not receiving as good an education as possible.

For example, planning and providing education for a class of students has traditionally been performed by the teacher of the class independently of other teachers. Also, during a typical grading period, a teacher may manage thousands of documents for hundreds of students. Generally, a substantial amount of the work to create, distribute, collect, score and record assignments is manually done by the teacher. The amount of time spent by a teacher performing these tasks substantially reduces the amount of time available for the teacher to provide mentoring for the students and to meet the individual needs of non-standard students, such as special education students or gifted students.

In addition, a teacher is typically unable to ascertain whether or not students are learning and understanding the material being presented until days or weeks after the teacher has presented the material. This is due to the fact that the students understanding or lack thereof is generally only seen by the teacher after providing a test on the material and manually scoring the test, which may not be done for some period of time after the test is given. Administrators and curriculum staff also have no way to timely, efficiently and effectively assess the level of student understanding within their school districts.

Also, learning materials provided to students are typically outdated. For example, the textbooks provided for students are often used for years, becoming more outdated for each succeeding class of students. In addition, assignments and other learning materials provided by teachers are often based on copies of older materials used by teachers in previous years and, thus, also quickly become outdated.

Furthermore, parental involvement in a student's education is generally limited. For example, a parent may only become aware that a child is struggling with a particular subject after it has become too late to seek additional assistance. In some situations, parental involvement may be limited to receiving a report card at the end of a grading period for signature.

Recently, educational systems have been developed in an attempt to solve some of these problems with education. However, each of these systems addresses only part of the problem. For example, one of the systems assists a teacher with lesson planning, while another provides for increased communication between parents and teachers.

### SUMMARY OF THE INVENTION

In accordance with the present invention, an integrated instructional management system and method are provided that substantially eliminate or reduce disadvantages and problems associated with previously developed systems and methods. In particular, teachers are provided with resources which eliminate a large amount of paperwork, freeing their time to mentor students, and students and parents are able to access assignments from any location.

In one embodiment of the present invention, a method for generating a lesson plan for a course is provided that includes associating a plurality of standard objectives with the course. A plurality of learning activities are provided for selection. Each learning activity is associated with at least one standard objective for the course. A selection of at least a subset of the learning activities is received. The lesson plan is generated based on the selected learning activities.

In another embodiment of the present invention, a course matrix for a course is provided that includes a time matrix, a plurality of teach topics, and a plurality of standard objectives. The time matrix comprises a plurality of time periods. The teach topics are each associated with a specified time period of the time matrix. The standard objectives are each associated with at least one teach topic.

In yet another embodiment of the present invention, a method for teaching a class is provided that includes releasing a learning activity. The learning activity is released by associating the learning activity with at least one student. A release instruction is received for the learning activity. Access is provided to the learning activity for the student associated with the learning activity.

In yet another embodiment of the present invention, a method for a student in a class to complete a learning activity released for the student is provided. The method includes accessing the learning activity. The learning activity comprises at least one assessment procedure. Responses are provided to a plurality of questions for the assessment procedure. A score for the assessment procedure is automatically received based on the responses provided.

In yet another embodiment of the present invention, a method for parental involvement in educating a student is provided that includes providing a parent of the student access to a plurality of learning activities for the student. At least a subset of the learning activities comprise an assessment procedure. The parent is provided a score for each of at least a subset of the assessment procedures completed by the student.

In yet another embodiment of the present invention, a method for transferring data from a source window to a destination window is provided. Each window comprises a document object model compatible web browser window operable to display Hypertext Markup Language. Data to be transferred from the source window is selected. A drag event is captured in the source window. The selected data is packaged into a data structure. The packaged data is stored in a data store. A drop event is captured in the destination window. The source window is queried for the data store. The stored data is transferred into the destination window.

Technical advantages of the present invention include providing an improved integrated instructional management system and method. In a particular embodiment, the integrated system provides an expertise repository including learning activities, questions, tests, and the like that are created by experienced teachers and/or curriculum staff. The material in the expertise repository is available to every teacher, thereby leveraging the knowledge of more experienced personnel for use by all the teachers.

Additionally, the integrated system provides for lesson planning, feedback for teachers, feedback for administrators, updated educational materials, modified activities for non-standard students, feedback for students, feedback for parents, parental involvement, automatic grading of objective assessments, and the like. As a result, a teacher may provide current teaching materials for students, may generate lesson plans with previously developed learning activities, and may have more time for mentoring students. Additionally, the integrated system reduces costs associated with implementing a plurality of systems for performing a subset of the functions provided by the integrated system.

Other technical advantages of the present invention include providing remote access to the integrated system such that school administrators, teachers, parents and students may access the system from their homes, while on vacation, or from any other location. In addition, a scheduling function allows a family to incorporate family events into the school schedule. The present invention also provides for communication between school administrators, teachers, parents and students.

Other technical advantages will be readily apparent to one skilled in the art from the following figures, description, and claims.

### BRIEF DESCRIPTION OF THE DRAWINGS

For a more complete understanding of the present invention and its advantages, reference is now made to the following description taken in conjunction with the accompanying drawings, wherein like numerals represent like parts, in which:

FIG. 1 is a block diagram illustrating an integrated instructional management system in accordance with one embodiment of the present invention;

FIG. 2 is a block diagram illustrating the server of FIG. 1 in accordance with one embodiment of the present invention;

FIG. 3 is a block diagram illustrating the course matrix of FIG. 2 in accordance with one embodiment of the present invention;

FIG. 4 is a block diagram illustrating the interaction of the systems of FIG. 2 in accordance with one embodiment of the present invention;

FIG. 5 is a flow diagram illustrating a method for implementing the integrated instructional management system of FIG. 1 in accordance with one embodiment of the present invention;

FIG. 6 is a flow diagram illustrating a method for creating a standards-based curriculum from the point of view of a user of the system of FIG. 1 in accordance with one embodiment of the present invention;

FIG. 7 is a flow diagram illustrating a method for creating a standards-based curriculum from the point of view of the system of FIG. 1 in accordance with one embodiment of the present invention;

FIG. 8 is a flow diagram illustrating a method for creating questions for the expertise repository of FIG. 2 from the point of view of a user of the system of FIG. 1 in accordance with one embodiment of the present invention;

FIG. 9 is a flow diagram illustrating a method for creating questions for the expertise repository of FIG. 2 from the point of view of the system of FIG. 1 in accordance with one embodiment of the present invention;

FIG. 10 is a flow diagram illustrating a method for creating a question-based assessment using the expertise repository of FIG. 2 from the point of view of a user of the system of FIG. 1 in accordance with one embodiment of the present invention;

FIG. 11 is a flow diagram illustrating a method for creating a question-based assessment using the expertise repository of FIG. 2 from the point of view of the system of FIG. 1 in accordance with one embodiment of the present invention;

FIG. 12 is a flow diagram illustrating a method for creating a rubric-based assessment from the point of view of a user of the system of FIG. 1 in accordance with one embodiment of the present invention;

FIG. 13 is a flow diagram illustrating a method for creating a rubric-based assessment from the point of view of the system of FIG. 1 in accordance with one embodiment of the present invention;

FIG. 14 is a flow diagram illustrating a method for creating learning activities for the expertise repository of FIG. 2 from the point of view of a user of the system of FIG. 1 in accordance with one embodiment of the present invention;

FIG. 15 is a flow diagram illustrating a method for creating learning activities for the expertise repository of FIG. 2 from the point of view of the system of FIG. 1 in accordance with one embodiment of the present invention;

FIG. 16 is a flow diagram illustrating a method for creating the lesson plan of FIG. 2 from the point of view of a user of the system of FIG. 1 in accordance with one embodiment of the present invention;

FIG. 17 is a flow diagram illustrating a method for creating the lesson plan of FIG. 2 from the point of view of the system of FIG. 1 in accordance with one embodiment of the present invention;

FIG. 18 is a flow diagram illustrating a method for scheduling the learning activities for the lesson plan of FIG. 2 from the point of view of a user of the system of FIG. 1 in accordance with one embodiment of the present invention;

FIG. 19 is a flow diagram illustrating a method for scheduling the learning activities for the lesson plan of FIG. 2 from the point of view of the system of FIG. 1 in accordance with one embodiment of the present invention;

FIG. 20 is a flow diagram illustrating a method for releasing the learning activities for the lesson plan of FIG. 2 from the point of view of a user of the system of FIG. 1 in accordance with one embodiment of the present invention;

FIG. 21 is a flow diagram illustrating a method for releasing the learning activities for the lesson plan of FIG. 2 from the point of view of the system of FIG. 1 in accordance with one embodiment of the present invention;

FIG. 22 is a flow diagram illustrating a method for utilizing the student system of FIG. 2 from the point of view of a user of the system of FIG. 1 in accordance with one embodiment of the present invention;

FIG. 23 is a flow diagram illustrating a method for providing the student system of FIG. 2 from the point of view of the system of FIG. 1 in accordance with one embodiment of the present invention;

FIG. 24 is a flow diagram illustrating a method for utilizing the parent system of FIG. 2 from the point of view of a user of the system of FIG. 1 in accordance with one embodiment of the present invention;

FIG. 25 is a flow diagram illustrating a method for providing the parent system of FIG. 2 from the point of view of the system of FIG. 1 in accordance with one embodiment of the present invention; and

FIG. 26 is a flow diagram illustrating a method for transferring data displayed on one of the access devices of FIG. 1 from a source window to a destination window in accordance with one embodiment of the present invention.

### DETAILED DESCRIPTION OF THE INVENTION

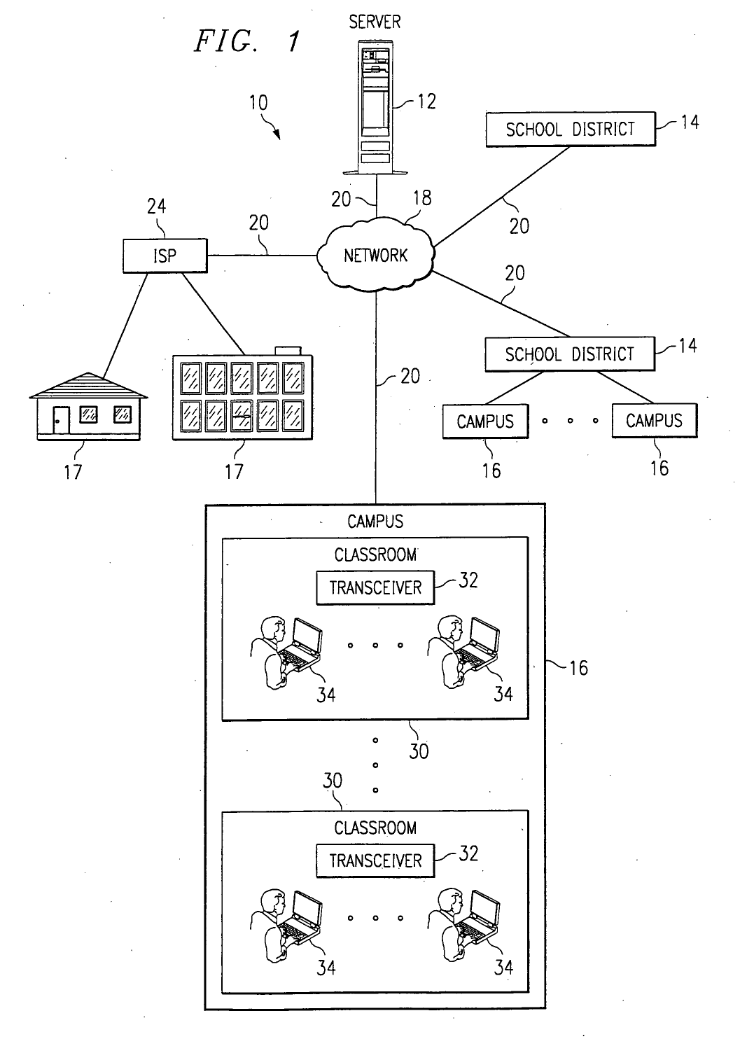

FIG. 1 is a block diagram illustrating an integrated instructional management system 10 in accordance with one embodiment of the present invention. The system 10 comprises one or more servers 12, a plurality of school districts 14, a plurality of campuses 16 and a plurality of peripheral structures 17 such as homes, office buildings and the like. The server 12, school districts 14, campuses 16 and peripheral structures 17 are coupled to one another and communicate through a network 18. The network 18 may provide this communication over a plurality of communication lines 20.

By allowing school administrators, teachers, parents and students to access the server 12 over the network 18, the system 10 is able to provide an integrated instructional management system operable to support the education of students from a variety of perspectives. For example, as described in more detail below, a teacher is provided with a variety of resources that result in the teacher having a substantially increased amount of time to mentor students and that provide the teacher with timely feedback allowing the teacher to focus on problem areas before moving forward. In addition, students receive immediate feedback after completing objective assessments provided by the system 10, and parents are able to monitor in real-time the progress of their children in school. The system 10 also provides administrative functions, standards-based curriculum design, reporting capabilities, and various other functions. According to one embodiment, the system 10 is used for primary education, including kindergarten through high school.

The communication lines 20 may be any type of communication link capable of supporting data transfer. In one embodiment, the communication lines 20 may comprise, alone or in combination, Integrated Services Digital Network, Asymmetric Digital Subscriber Line, T1 or T3 communication lines, hard-wire lines, telephone lines or wireless communication. It will be understood that the communication lines 20 may comprise other suitable types of data communication links. The communication lines 20 may also connect to a plurality of intermediate servers between the network 18 and the server 12, the school districts 14, the campuses 16 and the peripheral structures 17. For example, the communication lines 20 may connect to an Internet Service Provider 24 between the network 18 and the peripheral structures 17.

In one embodiment, the network 18 may comprise dial access via a telephone link. In this embodiment, the server 12, the school districts 14, the campuses 16 and the peripheral structures 17 may be remote from each other and located anywhere in the world. In one embodiment, the components 12, 14, 16 and 17 may connect and communicate with each other via modems and analog or digital communication lines. Moreover, the network 18 may be any interconnection found on any computer network such as a local area network, a wide area network, the Internet, or any other communications and data exchange systems created by connecting two or more computers.

According to one embodiment, the system 10 is accessible through any document object model (DOM) compatible web browser capable of displaying Hypertext Markup Language (HTML). Users may access the server 12 through the network 18 using devices such as web appliances, personal computers, or other suitable devices for accessing the server 12 via any DOM compatible web browser capable of displaying HTML. Therefore, users may access the server 12 through devices comprising no system-specific software and/or hardware.

As illustrated in FIG. 1, the network 18 may communicate with a campus 16 through a school district 14 or may communicate directly with a campus 16. In an alternative embodiment, the system 10 may be implemented entirely within a single school district 14 and its associated campuses 16.

Each campus 16 comprises a plurality of classrooms 30. According to one embodiment, each classroom 30 comprises two transceivers 32 and a plurality of access devices 34, with one access device 34 for each student and the teacher. It will be understood that any suitable number of transceivers 32 may be provided in any suitable locations within the campus 16 without departing from the scope of the present invention. The transceivers 32 may comprise Aironet transceivers, Lucent transceivers or other suitable transceivers. The access devices 34 may comprise web appliances, portable personal computers, or other suitable devices for accessing the network 18 through the transceivers 32 via any DOM compatible web browser capable of displaying HTML.

The transceivers 32 provide communication between the access devices 34 and the server 12. According to one embodiment, the transceivers 32 and the access devices 34 communicate through wireless communication. For this embodiment, each transceiver 32 is coupled to the server 12 through the network 18 and communicates with at least a subset of the access devices 34 through radio frequency signals, infrared signals or other suitable signals capable of being transmitted through the air. It will be understood, however, that the access devices 34 may be coupled to the network 18 via a physical communication line without departing from the scope of the present invention.

Each access device 34 may comprise a connection card for selecting which transceiver 32 will provide the highest quality signal at any particular time and for automatically processing hand-offs between transceivers 32. The access device 34 then communicates with the selected transceiver 32. In this way, each student can move around the campus 16 with his or her access device 34 while maintaining communication between the access device 34 and the server 12 through the use of multiple transceivers 32.

According to one embodiment, the system 10 provides advertisements to students on the access devices 34. These advertisements may be displayed based on the time of day. For example, advertisements for snacks, drinks and the like may be displayed at typical lunch or snack times, while advertisements for clothes, sports equipment, cosmetics, acne medication and the like are displayed after school hours. In addition, advertisements for orange juice, cereal, bagels and the like may be displayed at breakfast time, while advertisements for movies, miniature golf, bowling and the like are displayed on weekends. It will be understood that any suitable advertisements may be provided to the students at any suitable time without departing from the scope of the present invention. In addition, while administrative and curriculum staff, teachers and parents are accessing the system 10, advertisements directed to them may be provided.

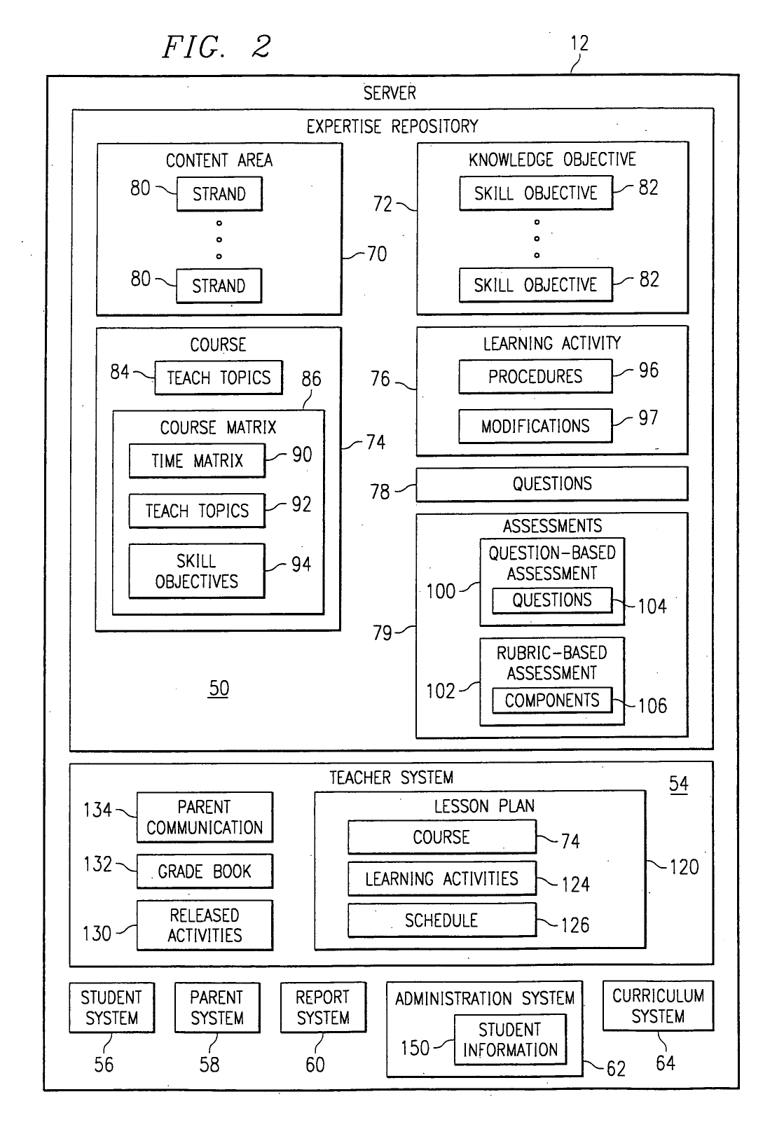

FIG. 2 is a block diagram illustrating the server 12 in accordance with one embodiment of the present invention. The server 12 comprises an expertise repository 50, a teacher system 54, a student system 56, a parent system 58, a report system 60, an administration system 62 and a curriculum system 64.

The expertise repository 50 allows the creation of a standards-based curriculum and provides a collection of teaching materials for teachers. Although the expertise repository 50 is illustrated separately from the systems 54, 56, 58, 60, 62 and 64 of the server 12, it will be understood that the expertise repository 50 may be otherwise suitably implemented without departing from the scope of the present invention. The expertise repository 50 comprises content areas 70, standard objectives such as knowledge objectives 72, courses 7, learning activities 76, questions 78 and assessments 79. The content areas 70 may be defined by a national or state education agency and may include, for example, social studies, language arts, mathematics, and the like.

Each content area 70 comprises a plurality of strands 80. For a content area 70 of social studies, for example, the strands 80 may include history, geography, economics, culture, government and the like. Each of the stands 80 is associated with one or more courses 74 that are associated with the content area 70 comprising the strand 80. The strands 80 may also be defined by an education agency.

Each strand 80 associated with a particular course 74 has one or more associated knowledge objectives 72′. These knowledge objectives 72 indicate what a student should learn with regard to the strand 80 in this particular course 74. For example, the content area 70 of language arts may have a strand 80 of writing for the course 74 of English grammar. This writing strand 80 may have a knowledge objective 72 of writing purposes. Thus, each student taking the course 74 of English grammar should learn about writing purposes.

Each knowledge objective 72 comprises a plurality of skill objectives 82. The skill objectives 82 indicate skills that a student should be able to perform in order to demonstrate that the associated knowledge objective 72 has been learned. For example, for the knowledge objective 72 of writing purposes, the skill objectives 82 may include writing poems, writing persuasively, writing in a style appropriate to a particular audience, and the like. It will be understood that the knowledge objectives 72 and skill objectives 82 may comprise any suitable implementation of standard objectives defined by a national, state, local or other suitable education agency.

Each course 74 comprises a plurality of associated teach topics 84 which are topics to be studied by students in the course 74. The teach topics 84 may be assigned to a particular course 74 by a school administrator, a curriculum planner or other suitable school official. For the course 74 of English grammar, for example, the teach topics 84 may include primitive civilizations, old English, punctuation, capitalization, and the like.

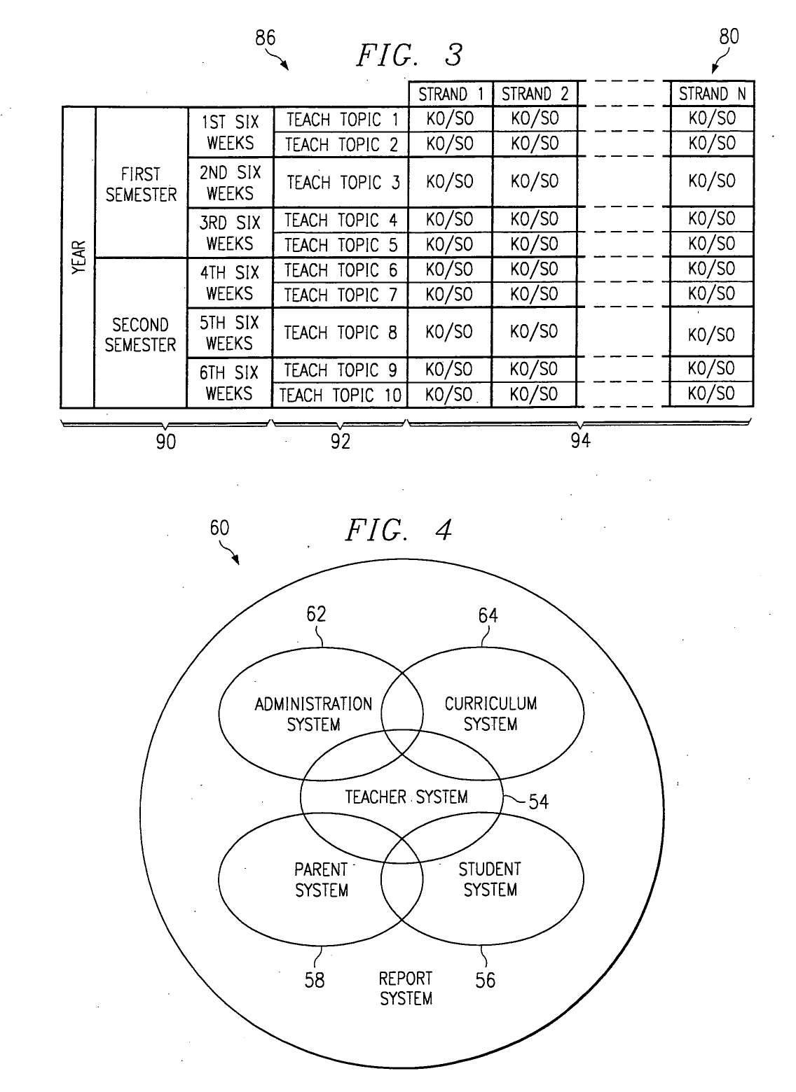

Each course 74 also comprises a course matrix 86 for organizing the course 74. The course matrix 86, as described in more detail below in connection with FIG. 3, comprises a time matrix 90, selected teach topics 92 chosen from the teach topics 84 for the course 74 and associated with specific time periods within the time matrix 90, and skill objectives 94 associated with specific teach topics 92.

According to one embodiment, the learning activities 76 are created by teachers and/or curriculum staff with a certain amount of experience and are available to be used by any other teacher. Thus, the knowledge of more experienced teachers is leveraged for use by all the teachers. Each learning activity 76 may include one or more procedures 96 for students to complete, such as a reading assignment and a test covering the reading assignment. Each learning activity 76 is associated with at least one skill objective 82 for a particular knowledge objective 72 that is associated with a strand 80 for the course 74 to which the learning activity 76 is assigned. The procedure 96 may include an assessment 79 from the expertise repository 50, described in more detail below.

In accordance with one embodiment, the procedures 96 comprise content procedures 96, which provide learning material for the students, assessment procedures 96, which assess the students understanding of the learning material and instructional procedures 96, which provide instructions to the students. Each procedure 96 may also include a link to a resource. For example, a content procedure 96 comprising a reading assignment may include a link to a web page which contains the information that the students are required to read and understand. It will be understood that a procedure 96 may include a link to any other suitable resource, such as a Microsoft Word document, an image file, a video file, an audio file and the like, without departing from the scope of the present invention.

Each learning activity 76 may be associated with a plurality of modifications 97. For example, in addition to a standard version of a learning activity 76, the learning activity 76 may be associated with modified versions of the learning activity 76, such as an accelerated modification 97 for gifted students, a dyslexic modification 97 for dyslexic students, a visually-impaired modification 97 for visually-impaired students, and the like. Thus, each learning activity 76 may be associated with any one or more of a variety of modifications 97.

In addition to modifications 97, each learning activity 76 may have an associated re-teach learning activity 76 and/or enrichment learning activity 76. A re-teach learning activity 76 teaches the same concepts and standards as another learning activity 76, but in a different manner. For example, a learning activity 76 may comprise a textual resource, while a re-teach learning activity 76 associated with that learning activity 76 may comprise an audio/visual resource. In this way, students who have difficulty with the original assignment are given an opportunity to learn the material in a different manner. Similarly, an enrichment learning activity 76 teaches similar concepts in a more challenging manner. Thus, if a student performs particularly well on a learning activity 76, the teacher may assign an enrichment learning activity 76 to that student to provide more in-depth coverage of the material.

According to one embodiment, learning activities 76 are each associated with a teach topic 92. Thus, while planning lessons for a particular teach topic 92, a teacher may select learning activities 76 from a group of learning activities 76 that are associated with that teach topic 92.

The expertise repository 50 comprises a plurality of questions 78. Each question 78 comprises a question type, such as multiple choice, true/false, short answer, and the like. In addition, for each question 78 which has a question type that provides for the selection of a correct response from a plurality of possible responses, the question 78 comprises both a correct response and one or more incorrect responses.

According to one embodiment, the questions 78 are created by teachers and/or curriculum staff with a certain amount of experience and are available to be used by any other teacher. Each question 78 is associated with at least one skill objective 82 for a particular knowledge objective 72 that is associated with a strand 80 for the course 74 in which the question 78 may be used. Each question 78 is also associated with a teach topic 84. In accordance with one embodiment, the questions 78 are also associated with modifications similar to the modifications 97 associated with the learning activities 76. Thus, a question 78 may be associated with a modification of the question 78 for non-standard students. For example, a question 78 that comprises an essay question may be associated with a modification for dyslexic students that comprises a short answer or multiple choice question.

The expertise repository 50 comprises a plurality of assessments 79. The assessments 79 comprise question-based assessments 100 and rubric-based assessments 102. According to one embodiment, the assessments 79 are created by teachers and/or curriculum staff with a certain amount of experience and are available to be used by any other teacher.

Questions 78 may be grouped together to form question-based assessments 100 that may be used as assessment procedures 96 in the learning activities 76. Thus, for example, a teacher may select a plurality of questions 78 from the expertise repository 50 to form a question-based assessment 100. The question-based assessment 100 then comprises a plurality of questions 104 corresponding to the questions 78 that were selected as they existed when the question-based assessment 100 was formed. In accordance with one embodiment, the question-based assessments 100 may also be associated with modifications for non-standard students such as those described above in connection with learning activities 76 and questions 78.

As an alternative to question-based assessments 100, a teacher may create a rubric-based assessment 102. Each rubric-based assessment 102 comprises one or more components 106. For example, a rubric-based assessment 102 comprising a speech may comprise components 106 such as knowledge of subject matter, visual aids, eye contact, overall presentation, and the like. Each component 106 may comprise a name, description, weight, minimum and maximum scores for the component, and the like.

The teacher system 54 of the server 12 comprises one or more lesson plans 120. Each lesson plan 120 is associated with a course 74. Thus, for example, if a teacher is teaching both algebra and geometry, the teacher may create a lesson plan 120 associated with an algebra course 74 and a lesson plan 120 associated with a geometry course 74.

After creating a lesson plan 120, a teacher uses the teacher system 54 to access the expertise repository 50 to select learning activities 124 for the lesson plan. These learning activities 124 correspond to the learning activities 76 as they existed when the learning activities 124 were selected. Thus, the teacher may search the expertise repository 50 for individual learning activities 76 in order to select learning activities 124 for the lesson plan 120 for a particular course 74. While searching the expertise repository 50 for learning activities 124, the teacher may search for learning activities 76 based on any suitable search criteria. For example, the teacher may search for learning activities 76 that are associated with a particular strand 80 for a teach topic 92 included in the course matrix 86 for the corresponding specified course 74.

After selecting a plurality of learning activities 124, the teacher may create a schedule 126 for the learning activities 124. When a teacher schedules a learning activity 124, the learning activity 124 is associated with a particular school day in the schedule 126. Thus, for example, a teacher may associate a learning activity 124 of a quadratic equation introduction with a specific date which happens to correspond to the 16th day of the school year. The teacher system 54 determines that the specific date chosen by the teacher corresponds to the 16th school day and stores an association between the quadratic equation introduction learning activity 124 and the 16th school day.

Thus, in a succeeding year, the lesson plan 120 previously created by the teacher automatically includes the quadratic equation introduction learning activity 124 on the 16th school day, which is generally on a different specific date. The association of a learning activity 124 to a specific date may be modified by the teacher at any time, resulting in the stored associated school day being automatically updated.

The teacher system 54 also comprises released activities 130. Released activities 130 comprise learning activities 124 that a teacher has assigned to one or more students by releasing those learning activities 124 to those students. Thus, for example, although the quadratic equation introduction learning activity 124 may be associated with the 16th school day, the teacher may decide not to release that learning activity 124 until the following day. After being released, the learning activity 124 is included as a released activity 130 in the teacher system 54 and is accessible by students for completion.

The teacher system 54 also comprises a grade book 132. This grade book 132 comprises scores for each student for each assessment procedure 96 in a released activity 130. For objective assessment procedures 96, the teacher system 54 automatically scores the procedure 96 and updates the grade book 132 with the score after receiving the responses from the student. Thus, after releasing a learning activity 124 with only objective assessment procedures 96, as opposed to subjective assessment procedures 96, the teacher has no more work to complete. As each student finishes the procedure or procedures 96 for that learning activity 124, the grade book 132 is automatically updated, at which point the teacher, the student, and the student's parents have immediate access to the score. For assessment procedures 96 that are subjective or that include both objective and subjective portions, the teacher accesses the students' responses through the grade book 132 in the teacher system 54 and provides for the subjective portion scores which are included in the grade book 132 along with the automatically scored objective portion. In this situation, the teacher, the student, and the student's parents have immediate access to the score for the objective portion.

The grade book 132 displays raw numerical scores for each assessment procedure 96 and also provides a color for each numerical score. Thus, for example, a score of 85 or above may be displayed with a green background, a score of 70 to 84 may be displayed with a yellow background, and a score of 69 or below may be displayed with a red background. An uncompleted assessment procedure 96 may be displayed as a white background without a score. It will be understood that any suitable colors, shading, icons or other suitable methods of differentiation between various scoring ranges may be used without departing from the scope of the present invention. The values for the raw numerical scores which correspond to different colors may be determined by a school administrator, a teacher or other suitable school official.

In addition to displaying raw numerical scores, the grade book 132 may comprise a mastery level view. For the mastery level view, the grade book 132 displays mastery levels associated with standards, such as knowledge objectives 72 and/or skill objectives 82, instead of displaying raw numerical scores. For this view, the grade book 132 may also display the mastery levels with associated colors, shading, icons or other suitable methods of differentiation between mastery levels.

Thus, a teacher may view the grade book 132 and intuitively see from the colors displayed whether or not the students understood the learning material covered by that assessment procedure 96. If a large portion of the students failed to understand, the grade book 132 will display the scores for those students in red. The large amount of red displayed by the grade book 132 alerts the teacher to the problem, enabling the teacher to provide more instruction on the same learning material before continuing on to other topics.

The teacher system 54 also comprises parent communication 134 which provides communication between a teacher and the parents of the teacher's students. For example, this communication may comprise e-mail communication. This allows the teacher to easily notify parents of any problems, inform parents of upcoming events or student progress, or provide any other type of communication directly to parents without relying on the students to transmit information back and forth. In addition, the parent communication 134 may automatically notify a parent, through e-mail or other suitable communication, when certain events occur, such as a student receiving a score below a pre-defined value, a student receiving a specified number of scores below a pre-defined value, or any other suitable event.

The server 12 also comprises a student system 56 that allows students to access and complete released activities 130, to access resources for the released activities 130, to receive immediate feedback for completed objective assessment procedures 96 and to view scores for all previously scored assessment procedures 96. The server 12 also comprises a parent system 58 that allows parents to communicate with teachers through the parent communication 134 of the teacher system 54, as described above, and to access released activities 130 for their children, as well as scores for completed assessment procedures 96 and other suitable information. In addition, the parent system 58 allows parents to view a schedule of school events and assignment due dates for their children. Parents may also add family events and appointments to this schedule in order to have a comprehensive family schedule.

The server 12 also comprises a report system 60 which is operable to generate a variety of reports, an administration system 62 that provides functions relating to student enrollment, teacher set-up, scheduling, grade reporting, attendance, discipline and other administrative functions, and a curriculum system 64 that provides functions relating to the design, development, management and distribution of standards-based curricula, and other curriculum-related functions. The curriculum system 64 may also be used to create and/or maintain the content areas 70, knowledge objectives 72, courses 74, course matrices 86, and the like.

The administration system 62 comprises student information 150. This information 150 may include, for example, the students' names, addresses and phone numbers, medical information, and the like. The student information 150 also includes data regarding any special needs of the students, such as whether each student is gifted, dyslexic, visually-impaired, or the like. This information 150 may be used in assigning modifications 97 of learning activities 124 to the students. The administration system 62 may also comprise information relating to school districts 14, campuses 16, teachers, administrators and the like.

The administration system 62 may also comprise a communication component for providing information to teachers, parents, students and the like. For example, the administration system 62 may be configured to automatically provide communication, such as through e-mail or other suitable form of communication, based upon triggering events. These triggering events may include the scheduling of an activity for which an activity fee needs to be paid, a need for proof of a particular immunization, and the like.

The server 12 also provides security, such as a login screen requiring the entry of a password or other suitable security, in order to maintain the integrity of the system 10. For example, some teachers may be given access to perform the functions provided by the teacher system 54 for only those teachers' classes and students, while other teachers may be given access to modify the expertise repository 50 by creating questions 78, assessments 79 and the like, as well as access to perform the functions provided by the teacher system 54 for their classes and students.

In addition, a student may be given access through the student system 56 to information relating to that particular student. Thus, the student is able to access only those activities 130 that have been released to that student and only his or her own scores, communications, and schedule. A parent may be given access through the parent system 58 to information relating to that parent's children. Thus, the parent is able to access only the activities 130 that have been released to their children, scores received by only their children, only their communications and the schedule only for their own family.

FIG. 3 is a block diagram illustrating a course matrix 86 for a course 74 in accordance with one embodiment of the present invention. As described above in connection with FIG. 2, the course matrix 86 comprises a time matrix 90, teach topics 92 and skill objectives 94 associated with strands 80. The time matrix 90 organizes the school year into a plurality of time periods. For example, as illustrated in FIG. 3, the school year may be divided into semesters which may be further divided into six-week periods. It will be understood that the time matrix 90 may be divided into other suitable time periods without departing from the scope of the present invention.

After creating the course matrix 86 for a specific course 74, a school official may select teach topics 84 for the course 74 to be associated with the time matrix 90. Thus, a teach topic 84 is selected and is associated as a teach topic 92 with a particular time period in the time matrix 90. As illustrated in FIG. 3, each time period may have one or more associated teach topics 92. It will be understood that a teach topic 92 may also be associated with more than one time period in the time matrix 90.

Each teach topic 92 has one or more associated skill objectives 94, each of which has an associated knowledge objective 72 as described above. A school official associates these skill objectives 94 with the teach topics 92 by selecting a teach topic 92 from the course matrix 86 along with a strand 80 corresponding to the course 74. After selecting the strand 80, the school official may select from one or more standard objective sources, such as a national or state education agency. According to one embodiment, the server 12 then provides the school official with knowledge objectives 72 and their associated skill objectives 82, from which the school official may select the appropriate skill objectives 82 to include as skill objectives 94 associated with the selected teach topic 92 in the course matrix 86. Thus, each strand 80 in the course matrix 86 may have zero, one or more skill objectives 94 for each teach topic 92.

FIG. 4 is a block diagram illustrating the interaction of the systems 54, 56, 58, 60, 62 and 64 in accordance with one embodiment of the present invention. According to the illustrated embodiment, the teacher system 54 interacts with each of the other systems 56, 58, 60, 62 and 64. The teacher system 54 interacts with the student system 56 by providing released activities 130, receiving completed assessment procedures 96, scoring objective assessment procedures 96, providing scores from the teacher for subjective assessment procedures 96, providing access to resources for content and/or assessment procedures 96, providing communication between students and teachers, providing a schedule of school events and assignment due dates, and the like.

The teacher system 54 interacts with the parent system 58 by providing communication between parents and teachers, providing access to released activities 130, providing scores for completed assessment procedures 96, providing a schedule of school events and assignment due dates, and allowing parents to add family events and appointments to the schedule.

The teacher system 54 may be affected by and maintained by the administration system 62 and the curriculum system 64. For example, the administration system 62 provides functions relating to student enrollment, teacher set-up, scheduling, grade reporting, attendance, discipline and other administrative functions, and the curriculum system 64 provides functions relating to the design, development, management and distribution of standards-based curricula, and other curriculum-related functions, in addition to creating and/or maintaining content areas 70, knowledge objectives 72, courses 74, and the like.

The teacher system 54 may also interact with the report system 60 by causing the report system 60 to generate a variety of reports for a teacher's use. For example, these reports may include charts of students' scores as they relate to a particular teach topic 92, students' scores as they relate to questions 78 associated with a particular skill objective 94, scores by class as they relate to a particular assessment procedure 96, and the like.

School officials using the administration system 62 and the curriculum system 64 may also use the report system 60 to generate a variety of reports. The report system 60 may interact with all the systems 54, 56, 58, 62 and 64 in order to retrieve the data required to perform the analysis to generate the reports. The reports generated by the report system 60 may comprise district-level reports, campus-level reports, principal reports, department-level reports, teacher reports, student reports and the like.

In addition, a color scheme similar to the one provided by the grade book 132, as described in more detail above in connection with FIG. 2, may be used in the reports to allow trends to be easily identified. Also, the associations provided between the components of the expertise repository 50, such as between content areas 70, strands 80, knowledge objectives 72, skill objectives 82, courses 74, teach topics 84, learning activities 76, questions 78, and the like, allow reports to be generated based on any of these components in order to identify problem areas or areas of excellence including mastery level of standard objectives for districts, campuses, departments, teachers, students, teach topics 84, skill objectives 82, and the like.

The student system 56 and the parent system 58 also interact with each other. For example, once a student completes an objective assessment procedure 96 through the student system 56, the teacher system 54 automatically scores the procedure 96 and provides the score to both the student system 56 and the parent system 58. Also, if a parent modifies the schedule provided by the parent system 58, the modified schedule may be viewed by a student through the student system 56.

The administration system 62 and the curriculum system 64 also interact with each other. For example, the standards-based curriculum developed with the curriculum system 64 may affect scheduling functions performed by the administration system 62. In addition, the administration system 62 and the curriculum system 64 may each interact with the student system 56 and the parent system 58 as necessary. For example, the systems 56, 58, 62 and 64 may share student information 150, parent information, district schedules, campus schedules, lunch schedules and the like.

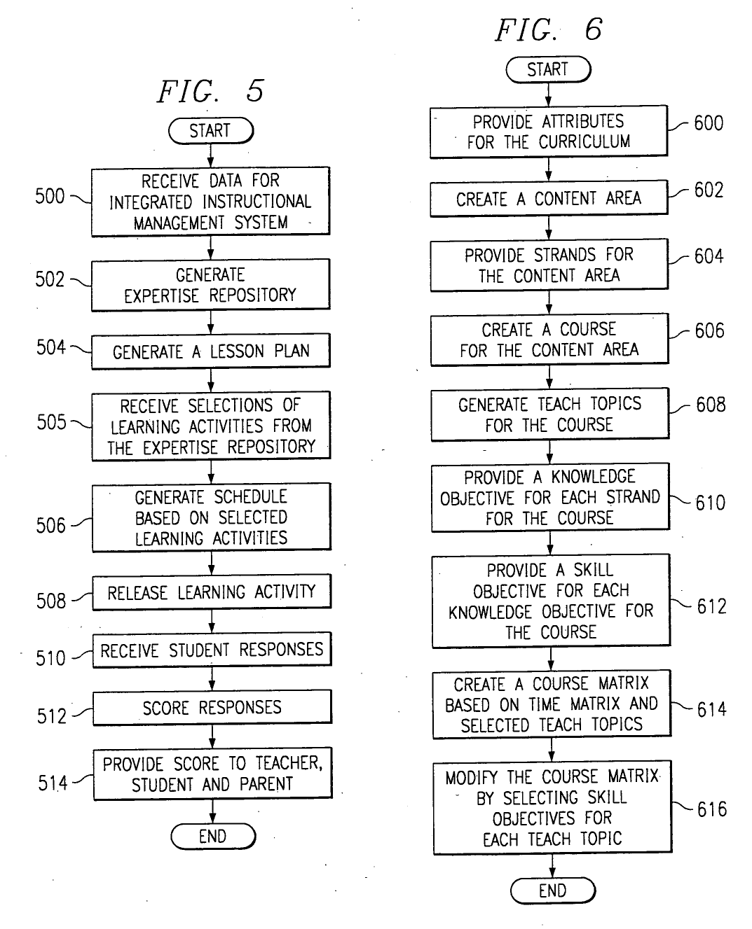

FIG. 5 is a flow diagram illustrating a method for implementing the integrated instructional management system 10 in accordance with one embodiment of the present invention. The method begins at step 500 where data is received for the system 10. For example, this data may include information relating to school districts 14, campuses 16, teachers, students, and the like. In addition, this data may include data for the expertise repository 50. This data for the expertise repository 50 may include content areas 70 and their associated strands 80, knowledge objectives 72 and their associated skill objectives 82, courses 74 and their associated teach topics 84 and course matrices 86, learning activities 76 and their associated procedures 96, as well as modifications 97 of the learning activities 76, questions 78, assessments 79, and any other suitable data.

At step 502, the expertise repository 50 is generated based on the data received for the expertise repository 50. At step 504, a lesson plan 120 is generated based on a title, a description and other suitable attributes for the lesson plan 120. This step may comprise associating a course 74 and a course matrix 86 with the lesson plan 120. At step 505, selections of one or more learning activities 76 from the expertise repository 50 are received. This step may comprise receiving a selection of a strand 80 associated with a teach topic 92. A selection of a learning activity 76 that is associated with the strand 80 is then received. Any modifications 98 associated with the selected learning activity 76 are automatically included with the selected learning activity 76 for the lesson plan 120.

At step 506, a schedule 126 is generated based on the selected learning activities 124. In this step, the learning activities 124 are associated with specific school days. At step 508 at least one learning activity 124 is released to at least one student. At step 510, responses for the released activity 130 are received from the student. At step 512, the responses are scored. If the responses are objective, the scoring is performed automatically. At step 514, the score is provided to the teacher, the student, and the parent, after which the method comes to an end. Accordingly, teacher-knowledge is leveraged, minimizing the amount of time that teachers are required to perform administrative functions, and automatic feedback on the released activities 130 is received, allowing teachers to focus on problem areas.

FIG. 6 is a flow diagram illustrating a method for creating a standards-based curriculum from the point of view of a user of the system 10 in accordance with one embodiment of the present invention. The method begins at step 600 where attributes for the curriculum are provided. This step may comprise providing grade levels and other suitable attributes for the curriculum. At step 602, a content area 70 is created. This step may comprise providing a title, a description and other suitable attributes for the content area 70. At step 604, strands 80 are provided for the content area 70.

At step 606, a course 74 is created for the content area 70. This step may comprise providing a title, description, grade level, subject and the like for the course 74. At step 608, a plurality of teach topics 84 are generated for the course 74. This step may comprise providing a title and other suitable attributes for each teach topic 84.

At step 610, at least one knowledge objective 72 is provided for each strand 80 for the course 74. At step 612, at least one skill objective 82 is provided for each knowledge objective 72 for the course 74. At step 614, a course matrix 86 is created based on the time matrix 90 and on the teach topics 92 selected from the teach topics 84. This step may comprise providing a title, a description and other suitable attributes for the course matrix 86. At step 616, the course matrix 86 is modified to include skill objectives 94 by selecting skill objectives 82 for each teach topic 92 in the course matrix 86. In this way, a curriculum based on national, state or other standards may be created.

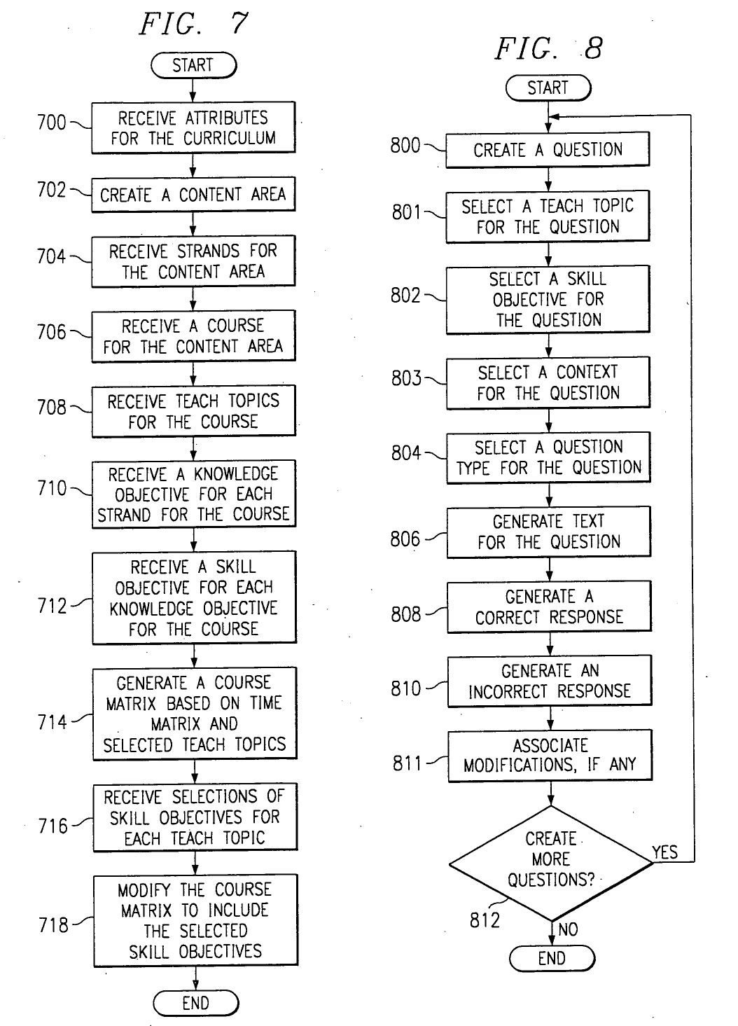

FIG. 7 is a flow diagram illustrating a method for creating a standards-based curriculum from the point of view of the system 10 in accordance with one embodiment of the present invention. The method begins at step 700 where attributes for the curriculum are received. These attributes may comprise grade levels and other suitable attributes. At step 702, a content area 70 is created based on attributes such as a title, a description and the like. At step 704, strands 80 are received for the content area 70.

At step 706, a course 74 is received for the content area 70. This step may comprise receiving attributes for the course 74, such as a title, description, grade level, subject and the like. At step 708, a plurality of teach topics 84 are received for the course 74. This step may comprise receiving attributes such as a title for each teach topic 84.

At step 710, at least one knowledge objective 72 is received for each strand 80 for the course 74. At step 712, at least one skill objective 82 is received for each knowledge objective 72 for the course 74. At step 714, a course matrix 86 is generated based on the time matrix 90 and on the teach topics 92 selected from the teach topics 84. This step may comprise receiving attributes for the course matrix 86 such as a title and a description. At step 716, skill objectives 94 selected from the skill objectives 82 are received for each teach topic 92. At step 718, the course matrix 86 is modified to include the selected skill objectives 94, after which the method comes to an end and a standards-based curriculum is saved in the system 10. In this way, a curriculum based on national, state or other standards may be created.

FIG. 8 is a flow diagram illustrating a method for creating questions 78 for the expertise repository 50 from the point of view of a user of the system 10 in accordance with one embodiment of the present invention. The method begins at step 800 where a question 78 is created. At step 801, a teach topic 84 is selected for the question 78. At step 802, a skill objective 82 is selected for the question 78. At step 803, a context is selected for the question 78. The context may be used to organize similar questions 78. The context may comprise a visual aid, an audio aid, a short essay, a teacher-created instruction or the like. At step 804, a question type is selected for the question 78. The question type may include, for example, multiple choice, true/false, short answer, matching and the like.

At step 806, text is generated for the question 78. At step 808, a correct response to the question 78 is generated. At step 810, an incorrect response to the question 78 is generated, if applicable. For example, for questions 78 with a question type of short answer, matching or the like, an incorrect response need not be generated. It will be understood that any suitable number of incorrect responses may be provided for a question 78. At step 811, one or more modifications may be associated with the question 78 and the question 78 is saved in the system 10.

At decisional step 812, a decision is made regarding whether there are more questions 78 to create. If more questions 78 are to be created, the method follows the Yes branch from decisional step 812 to step 800 where another question 78 is created for the teach topic 84. However, if there are no more questions 78 to create, the method follows the No branch from decisional step 812 and comes to an end. In this way, questions 78 for the expertise repository 50 may be created by more experienced teachers for use by all teachers.

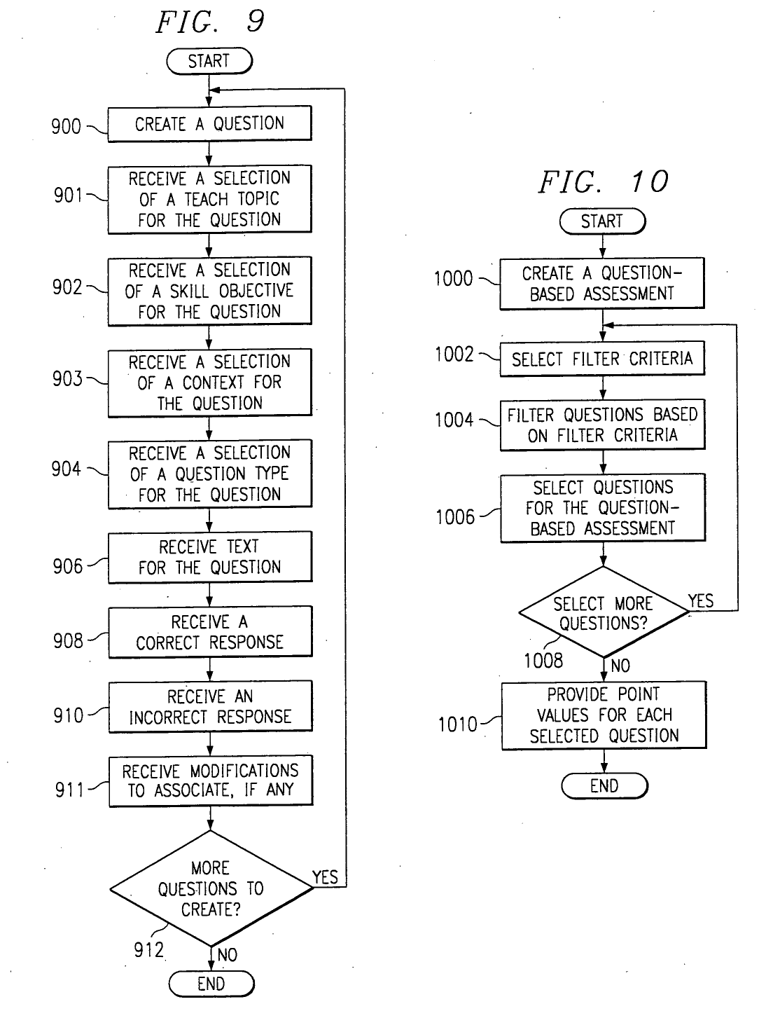

FIG. 9 is a flow diagram illustrating a method for creating questions 78 for the expertise repository 50 from the point of view of the system 10 in accordance with one embodiment of the present invention. The method begins at step 900 where a question 78 is created. At step 901, a selection of a teach topic 84 is received for the question 78. At step 902, a selection of a skill objective 82 is received for the question 78. At step 903, a selection of a context is received for the question 78. The context may be used to organize similar questions 78. The context may comprise a visual aid, an audio aid, a short essay, a teacher-created instruction or the like. At step 904, a selection of a question type is received for the question 78.

At step 906, text for a question 78 is received. At step 908, a correct response to the question 78, is received. At step 910, an incorrect response to the question 78 is received, if applicable. At step 911, one or more modifications may be received for association with the question 78 and the question 78 is saved in the system 10.

At decisional step 912, a decision is made regarding whether there are more questions 78 to create. If more questions 78 are to be created, the method follows the Yes branch from decisional step 912 to step 900 where another question 78 is created for the teach topic 84. However, if there are no more questions 78 to be created, the method follows the No branch from decisional step 912 and comes to an end. In this way, questions 78 for the expertise repository 50 may be created by more experienced teachers for use by all teachers.

FIG. 10 is a flow diagram illustrating a method for creating a question-based assessment 100 using the expertise repository 50 from the point of view of a user of the system 10 in accordance with one embodiment of the present invention. The method begins at step 1000 where a question-based assessment 100 is created. This step may comprise providing a title, a description and other suitable attributes for the question-based assessment 100. In addition, a course 74 may be associated with the question-based assessment 100. At step 1002, filter criteria are selected for the filtering available questions 78. This filter criteria may include, for example, question authors, question contexts, question types, teach topics 84, skill objectives 82, and the like. At step 1004, the questions 78 are filtered are based on the selected filter criteria. At step 1006, questions 104 are selected for the question-based assessment 100.

At decisional step 1008, a decision is made regarding whether more questions 104 are to be selected for the question-based assessment 100. If more questions 104 are to be selected, the method follows the Yes branch from decisional step 1008 and returns to step 1002 where filter criteria are selected. However, if there are no more questions 104 to be selected for the question-based assessment 100, the method follows the No branch from decisional step 1008 to step 1010. At step 1010, point values are provided for each question 104 in, after which the method comes to an end and the question-based assessment 100 is saved in the system 10. In this way, question-based assessments 100 for the expertise repository 50 may be created for use by all teachers.

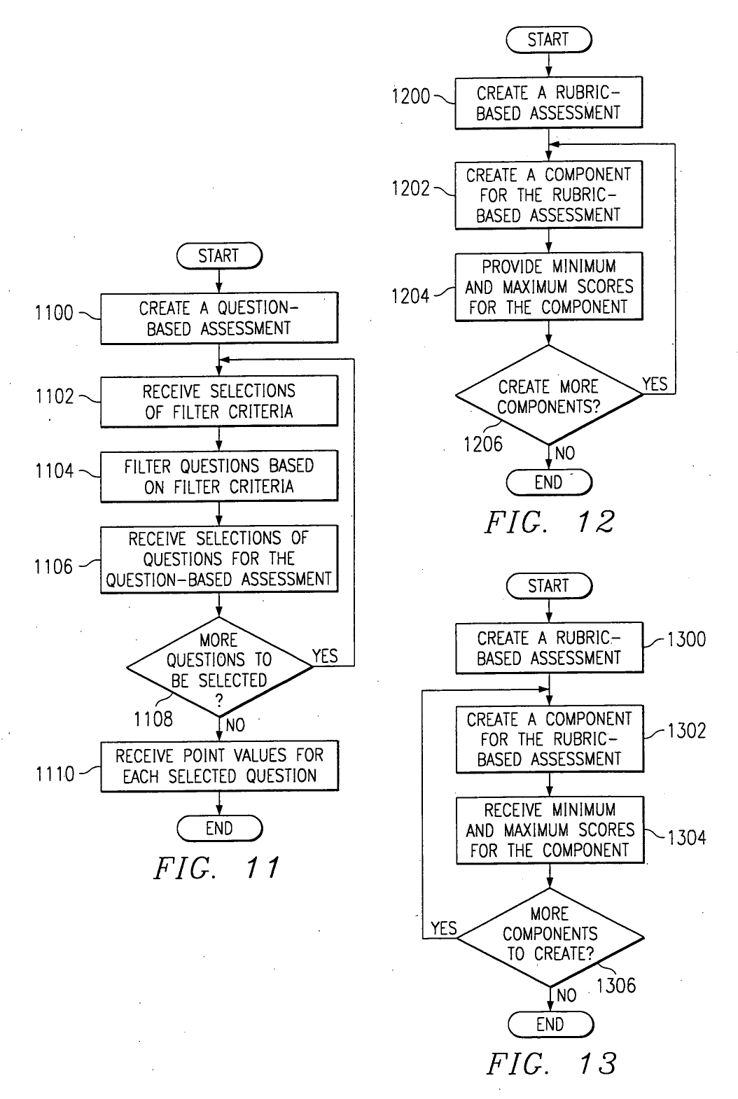

FIG. 11 is a flow diagram illustrating a method for creating a question-based assessment 100 using the expertise repository 50 from the point of view of the system 10 in accordance with one embodiment of the present invention. The method begins at step 1100 where a question-based assessment 100 is created. This step may comprise receiving attributes for the question-based assessment 100 such as a title, a description, a course 74 associated with the question-based assessment 100, and the like. At step 1102, selections of filter criteria are received. At step 1104, the questions 78 are filtered are based on the selected filter criteria. At step 1106, selections of questions 104 for the question-based assessment 100 are received.

At decisional step 1108, a decision is made regarding whether more questions 104 are to be selected for the question-based assessment 100. If more questions 104 are to be selected, the method follows the Yes branch from decisional step 1108 and returns to step 1102 where selections of filter criteria are received. However, if there are no more questions 104 to be selected for the question-based assessment 100, the method follows the No branch from decisional step 1108 to step 1110. At step 1110, point values are received for each question 104 in the question-based assessment 100, after which the method comes to an end and the question-based assessment 100 is saved in the system 10. In this way, question-based assessments 100 for the expertise repository 50 may be created for use by all teachers.

FIG. 12 is a flow diagram illustrating a method for creating a rubric-based assessment 102 from the point of view of a user of the system 10 in accordance with one embodiment of the present invention. The method begins at step 1200 where a rubric-based assessment 102 is created. This step may comprise providing a title, a description and other suitable attributes for the rubric-based assessment 102. In addition, a course 74 may be associated with the rubric-based assessment 102.

At step 1202, a component 106 is created for the rubric-based assessment 102. This step may comprise providing a title, description, weight and other suitable attributes for the component 106. At step 1204, minimum and maximum scores are provided for the component 106. After all the components 106 have been included in the rubric-based assessment 102, the total of the maximum scores provided for each component 106 corresponds to the highest possible score a student may receive for that rubric-based assessment 102.

At decisional step 1206, a decision is made regarding whether there are more components 106 to create. If more components 106 are to be created, the method follows the Yes branch from decisional step 1206 to step 1202 where another component 106 is created for the rubric-based assessment 102. However, if there are no more components 106 to create, the method follows the No branch from decisional step 1206 and comes to an end and the rubric-based assessment 102 is saved in the system 10. In this way, rubric-based assessments 102 for the expertise repository 50 may be created for use by all teachers.

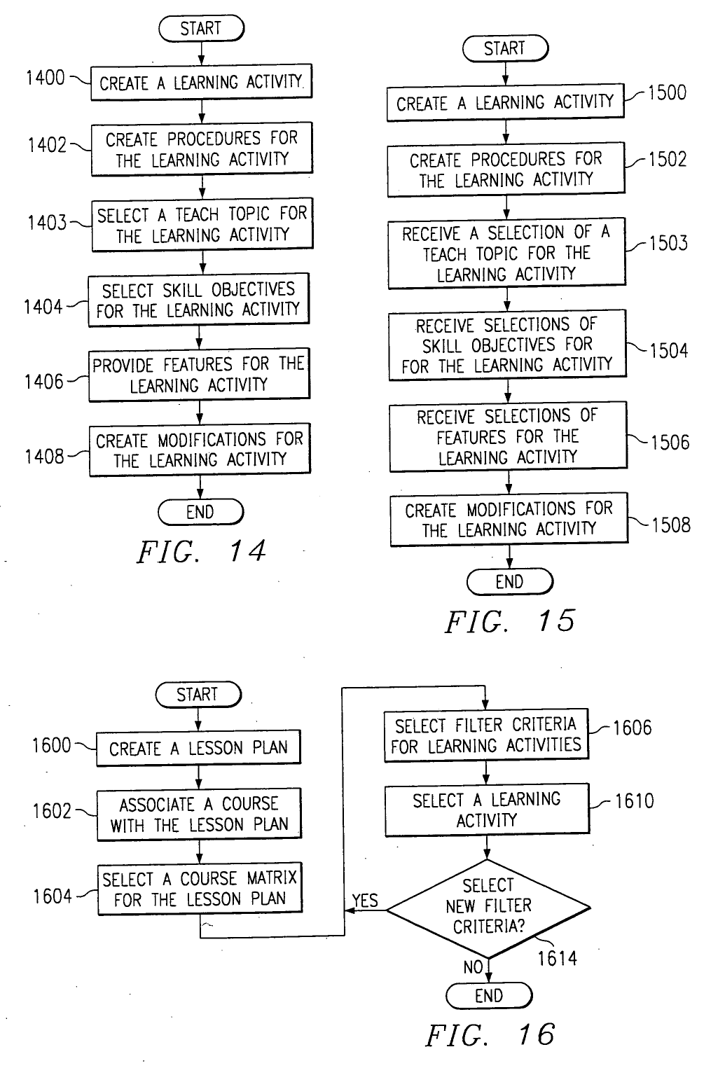

FIG. 13 is a flow diagram illustrating a method for creating a rubric-based assessment 102 from the point of view of the system 10 in accordance with one embodiment of the present invention. The method begins at step 1300 where a rubric-based assessment 102 is created. This step may comprise receiving attributes for the rubric-based assessment 102 such as a title, a description and the like. In addition, a course 74 may be associated with the rubric-based assessment 102.

At step 1302, a component 106 is created for the rubric-based assessment 102. This step may comprise receiving attributes for the component 106 such as a title, description, weight and the like. At step 1304, minimum and maximum scores are received for the component 106. After all the components 106 have been included in the rubric-based assessment 102, the total of the maximum scores received for each component 106 corresponds to the highest possible score a student may receive for that rubric-based assessment 102.

At decisional step 1306, a decision is made regarding whether there are more components 106 to be created. If more components 106 are to be created, the method follows the Yes branch from decisional step 1306 to step 1302 where another component 106 is created for the rubric-based assessment 102. However, if there are no more components 106 to be created, the method follows the No branch from decisional step 1306 and comes to an end and the rubric-based assessment 102 is saved in the system 10. In this way, rubric-based assessments 102 for the expertise repository 50 may be created for use by all teachers.

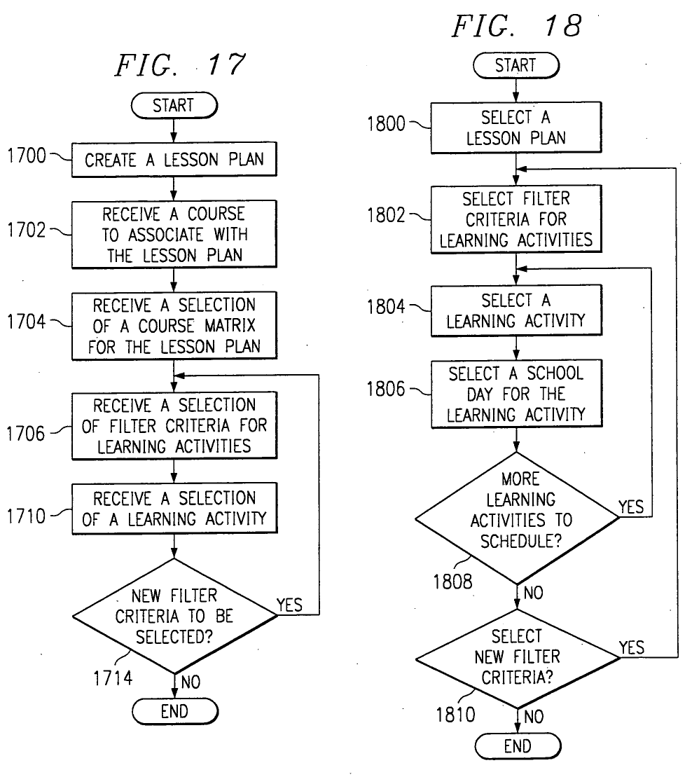

FIG. 14 is a flow diagram illustrating a method for creating learning activities 76 for the expertise repository 50 from the point of view of a user of the system 10 in accordance with one embodiment of the present invention. The method begins at step 1400 where a learning activity 76 is created. This step may comprise providing a title and an activity type for the learning activity 76. In addition, this step may comprise providing an estimated duration, goals and other suitable attributes for the learning activity 76.

At step 1402, at least one procedure 96 is created for the learning activity 76. This step may comprise providing a procedure type, a description, a link type, a procedure link and the like for each procedure 96 that is created. At step 1403, at least one teach topic 84 is selected for the learning activity 76. At step 1404, at least one skill objective 82 is selected for the learning activity 76.

At step 1406, other features are provided for the learning activity 76, such as non-system resources, teacher notes, keywords and the like. Non-system resources may comprise, for example, a book, construction paper, scissors, or any other suitable non-system resource needed to complete the learning activity 76. Teacher notes may comprise comments from the teacher that are related to the learning activity 76. Keywords may comprise words and/or phrases provided by the teacher that may be used as filter criteria when searching for particular learning activities 76.

At step 1408, modifications 97 are created for the learning activity 76, after which the method comes to an end and the learning activity 76 is saved in the system 10. Thus, as described in more detail above in connection with FIG. 2, each learning activity 76 may be associated with one or more modifications 97 to accommodate the special needs of non-standard students. In this way, learning activities 76 for the expertise repository 50 may be created by more experienced teachers for use by all teachers.

FIG. 15 is a flow diagram illustrating a method for creating learning activities 76 for the expertise repository 50 from the point of view of the system 10 in accordance with one embodiment of the present invention. The method begins at step 1500 where a learning activity 76 is created. This step may comprise receiving attributes for the learning activity 76 such as a title, an activity type, an estimated duration, goals and the like.

At step 1502, at least one procedure 96 is created for the learning activity 76. This step may comprise receiving attributes for each procedure 96 that is created such as a procedure type, description, link type, procedure link and the like. At step 1503, a selection of at least one teach topic 84 is received for the learning activity 76. At step 1504, a selection of at least one skill objective 82 is received for the learning activity 76.

At step 1506, selections of other features are received for the learning activity 76, such as non-system resources, teacher notes, keywords and the like. Non-system resources may comprise, for example, a book, construction paper, scissors, or any other suitable non-system resource needed to complete the learning activity 76. Teacher notes may comprise comments from the teacher that are related to the learning activity 76. Keywords may comprise words and/or phrases provided by the teacher that may be used as filter criteria when searching for particular learning activities 76.

At step 1508, modifications 97 are created for the learning activity 76, after which the method comes to an end and the learning activity 76 is saved in the system 10. Thus, as described in more detail above in connection with FIG. 2, each learning activity 76 may be associated with one or more modifications 97 to accommodate the special needs of non-standard students. In this way, learning activities 76 for the expertise repository 50 may be created by more experienced teachers for use by all teachers.

FIG. 16 is a flow diagram illustrating a method for creating a lesson plan 120 from the point of view of a user of the system 10 in accordance with one embodiment of the present invention. The method begins at step 1600 where a lesson plan 120 is created. This step may comprise providing a title, a description and other suitable attributes for the lesson plan 120. At step 1602, a course 74 is associated with the lesson plan 120. At step 1604, a course matrix 86 is selected for the lesson plan 120.

At step 1606, filter criteria are selected for the learning activities 76. These filter criteria may comprise, for example, one or more of a time matrix 90, a teach topic 92, a strand 94, a knowledge objective 72, a skill objective 82, a keyword, or the like. At step 1610, a learning activity 76 is selected for the lesson plan 120 from the filtered learning activities 76. Any modifications 98 associated with the selected learning activity 76 are automatically included with the selected learning activity 76 for the lesson plan 120.

At decisional step 1614, a determination is made regarding whether new filter criteria are to be selected. If new filter criteria are to be selected, the method follows the Yes branch from decisional step 1614 and returns to step 1606 for the selection of new filter criteria. However, if new filter criteria are not to be selected, the method follows the No branch from decisional step 1614 and comes to an end and the lesson plan 120 is saved in the system 10. In this way, teachers may create lesson plans 120 based on the learning activities 76 included in the expertise repository 50 as prescribed by the course matrix 86.

FIG. 17 is a flow diagram illustrating a method for creating a lesson plan 120 from the point of view of the system 10 in accordance with one embodiment of the present invention. The method begins at step 1700 where a lesson plan 120 is created. This step may comprise receiving attributes for the lesson plan 120 such as a title, description and the like. At step 1702, a course 74 is received for association with the lesson plan 120. At step 1704, a selection of a course matrix 86 is received for the lesson plan 120.

At step 1706, a selection of filter criteria for the learning activities 76 is received. These filter criteria may comprise, for example, one or more of a time matrix 90, a teach topic 92, a strand 94, a knowledge objective 72, a skill objective 82, a keyword, or the like. At step 1710, a selection of a learning activity 76 from the filtered learning activities 76 is received for the lesson plan 120. If there are any modifications 97 associated with the selected learning activity 76, the modifications 97 are automatically received with the selected learning activity 76 for the lesson plan 120.

At decisional step 1714, a determination is made regarding whether new filter criteria are to be selected. If new filter criteria are to be selected, the method follows the Yes branch from decisional step 1714 and returns to step 1706 for the receipt of new filter criteria selections. However, if no new filter criteria are to be selected, the method follows the No branch from decisional step 1714 and comes to an end and the lesson plan 120 is saved in the system 10. In this way, lesson plans 120 may be created based on the learning activities 76 included in the expertise repository 50 as prescribed by the course matrix 86.

FIG. 18 is a flow diagram illustrating a method for scheduling the learning activities 124 for the lesson plan 120 from the point of view of a user of the system 10 in accordance with one embodiment of the present invention. The method begins at step 1800 where a lesson plan 120 is selected. At step 1802, filter criteria are selected for the learning activities 124. These filter criteria may comprise, for example, one or more of a time matrix 90, a teach topic 92, a strand 94, a knowledge objective 72, a skill objective 82, a keyword, or the like.

At step 1804, a learning activity 124 is selected from the filtered learning activities 124. At step 1806, a specific date or school day is selected for the learning activity 124. At this point, the learning activity 124 has been scheduled. According to one embodiment, the learning activity 124 may be re-scheduled by selecting a different date or school day for the learning activity 124 at this or any other time. In addition, the learning activity 124 may be removed from the schedule by removing the selection of the date or school day for that learning activity 124. This re-scheduling or removal of a learning activity 124 may be accomplished in the same way as the original scheduling of the learning activity 124.

At decisional step 1808, a determination is made regarding whether there are more learning activities 124 to schedule based on the previously selected filter criteria. If there are more learning activities 124 to schedule based on the previously selected filter criteria, the method follows the Yes branch from decisional step 1808 and returns to step 1804 for the selection of another learning activity 124. However, if there are no more learning activities 124 to schedule based on the previously selected filter criteria, the method follows the No branch from decisional step 1808 to decisional step 1810.

At decisional step 1810, a determination is made regarding whether new filter criteria are to be selected. If new filter criteria are to be selected, the method follows the Yes branch from decisional step 1810 and returns to step 1802 for the selection of new filter criteria. However, if no new filter criteria are to be selected, the method follows the No branch from decisional step 1810 and comes to an end. In this way, teachers may schedule learning activities 124 included in their lesson plans 120.

FIG. 19 is a flow diagram illustrating a method for scheduling the learning activities 124 for the lesson plan 120 from the point of view of the system 10 in accordance with one embodiment of the present invention. The method begins at step 1900 where a selection of a lesson plan 120 is received. At step 1902, a selection of filter criteria is received. These filter criteria may comprise, for example, one or more of a time matrix 90, a teach topic 92, a strand 94, a knowledge objective 72, a skill objective 82, a keyword, or the like.

At step 1904, a selection of a learning activity 124 is received from the filtered learning activities 124. At step 1906, a selection of a specific date or school day is received for the learning activity 124. At this point, the learning activity 124 has been scheduled. According to one embodiment, the learning activity 124 may be re-scheduled by receiving a selection of a different date or school day for the learning activity 124 at this or any other time. In addition, the learning activity 124 may be removed from the schedule by removing the selection of the date or school day for that learning activity 124. This re-scheduling or removal of a learning activity 124 may be accomplished in the same way as the original scheduling of the learning activity 124.

At decisional step 1908, a determination is made regarding whether there are more learning activities 124 to be scheduled based on the previously selected filter criteria. If there are more learning activities 124 to be scheduled based on the previously selected filter criteria, the method follows the Yes branch from decisional step 1908 and returns to step 1904 for the receipt of another learning activity 124 selection. However, if there are no more learning activities 124 to be scheduled based on the previously selected filter criteria, the method follows the No branch from decisional step 1908 to decisional step 1910.

At decisional step 1910, a determination is made regarding whether new filter criteria are to be selected. If new filter criteria are to be selected, the method follows the Yes branch from decisional step 1910 and returns to step 1902 for the receipt of new filter criteria selections. However, if no new filter criteria are to be selected, the method follows the No branch from decisional step 1910 and comes to an end. In this way, learning activities 124 included in a lesson plan 120 may be scheduled.

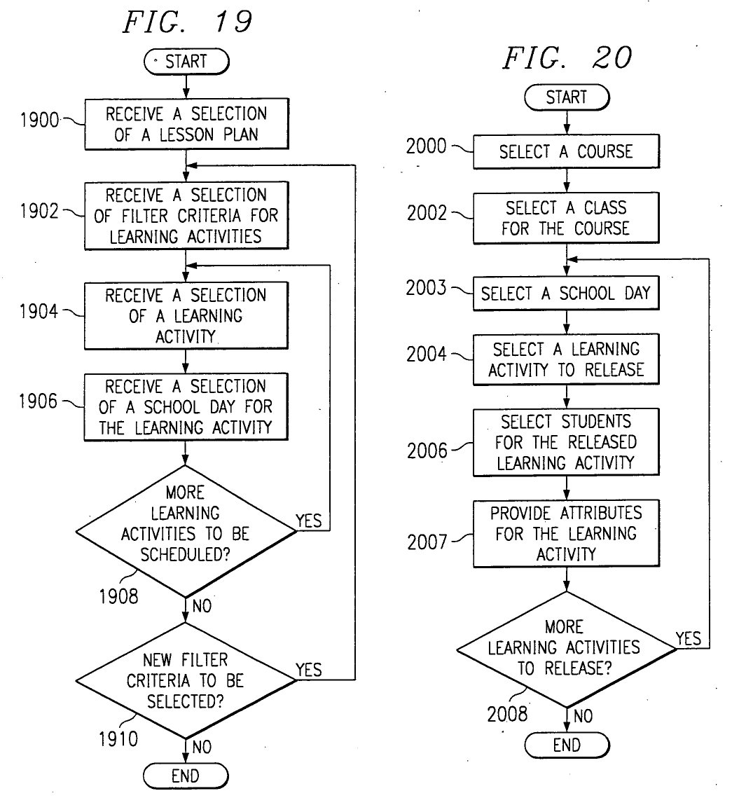

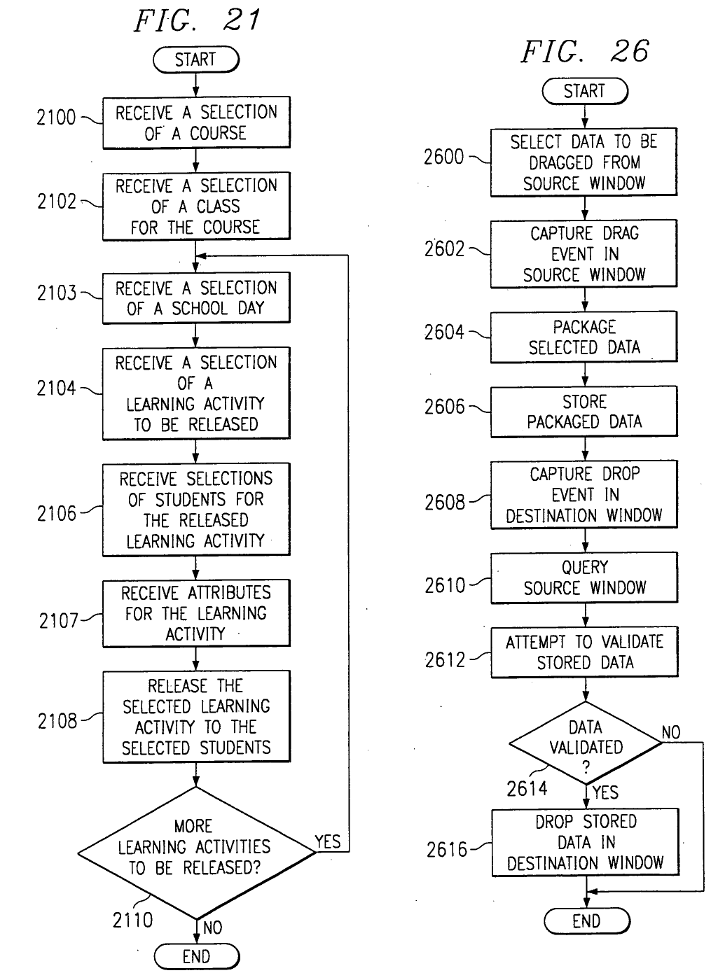

FIG. 20 is a flow diagram illustrating a method for releasing the learning activities 124 for the lesson plan 120 from the point of view of a user of the system 10 in accordance with one embodiment of the present invention. The method begins at step 2000 where a course 74 is selected. At step 2002, a class is selected for the course 74. At step 2003, a school day is selected for which one or more learning activities 124 are scheduled. At step 2004, a learning activity 124 is selected for release.

At step 2006, one or more students are selected to receive the released activity 130. If the released activity 130 comprises a modification 97 for dyslexia, for example, dyslexic students in the class are selected to receive the activity 130. According to one embodiment, if the learning activity 124 being released comprises a standard learning activity 124 that is associated with modifications 97 and one or more of the students selected to receive the released activity 130 is a non-standard student, the system 10 may notify the teacher releasing the learning activity 124 and request or require the teacher to give an explanation as to why the modification 97 is not being released to the non-standard student.

At step 2007, attributes are provided for the learning activity 124, after which the learning activity 124 is released to the selected students. The attributes may comprise a name for the learning activity 124 to be entered into the grade book 132, an assessment type, such as daily work, major test, or the like, a due date, and any other suitable attributes for the learning activity 124. The attributes may also comprise, for example, a randomization indicator and a timed indicator. The randomization indicator allows the teacher to indicate whether or not to randomize question and/or answer order to minimize the possibility of cheating. The timed indicator allows the teacher, if desired, to set a time limit for completing any assessment 79 associated with the learning activity 124. In one embodiment, when accessing a timed assessment 79, a student receives a notice regarding the time allotted for completion before beginning the assessment 79 and a timer to keep track of elapsed time during completion of the assessment 79. After the time period expires, the current responses to the assessment 79 are automatically submitted for grading.

At decisional step 2008, a determination is made regarding whether there are more learning activities 124 to be released. If there are more learning activities 124 to be released, the method follows the Yes branch from decisional step 2008 and returns to step 2003 for the selection of the same or another school-day. However, if there are no more learning activities 124 to be released, the method follows the No branch from decisional step 2008 and comes to an end. In this way, teachers may release learning activities 124 to students for completion.

FIG. 21 is a flow diagram illustrating a method for releasing the learning activities 124 for the lesson plan 120 from the point of view of the system 10 in accordance with one embodiment of the present invention. The method begins at step 2100 where a selection of a course 74 is received. At step 2102, a selection of a class is received for the course 74. At step 2103, a selection of a school day for which one or more learning activities 124 are scheduled is received. At step 2104, a selection of a learning activity 124 is received for release.

At step 2106, selections of one or more students to receive the learning activity 124 are received. If the released activity 130 comprises a modification 97 for dyslexia, for example, selections of dyslexic students in the class are received. According to one embodiment, if the learning activity 124 being released comprises a standard learning activity 124 that is associated with modifications 97 and one or more of the students selected to receive the released activity 130 is a non-standard student, a notification is provided to the teacher releasing the learning activity 124 and the teacher is requested or required to give an explanation as to why the modification 97 is not being released to the non-standard student.

At step 2107, attributes are received for the learning activity 124. For example, these attributes may comprise a name for the learning activity 124 to be entered into the grade book 132, an assessment type, such as daily work, major test, or the like, a due date, and any other suitable attributes for the learning activity 124. The attributes may also comprise, for example, a randomization indicator and a timed indicator. The randomization indicator allows the teacher to indicate whether or not to randomize question and/or answer order to minimize the possibility of cheating. The timed indicator allows the teacher, if desired, to set a time limit for completing any assessment 79 associated with the learning activity 124. In one embodiment, when accessing a timed assessment 79, a student receives a notice regarding the time allotted for completion before beginning the assessment 79 and a timer to keep track of elapsed time during completion of the assessment 79. After the time period expires, the current responses to the assessment 79 are automatically submitted for grading.

At step 2108, the selected learning activity 124 is released to the selected students. At decisional step 2110, a determination is made regarding whether there are more learning activities 124 to be released. If there are more learning activities 124 to be released, the method follows the Yes branch from decisional step 2110 and returns to step 2103 for the receipt of a selection of the same or another school day. However, if there are no more learning activities 124 to be released, the method follows the No branch from decisional step 2110 and comes to an end. In this way, learning activities 124 may be released to students for completion.

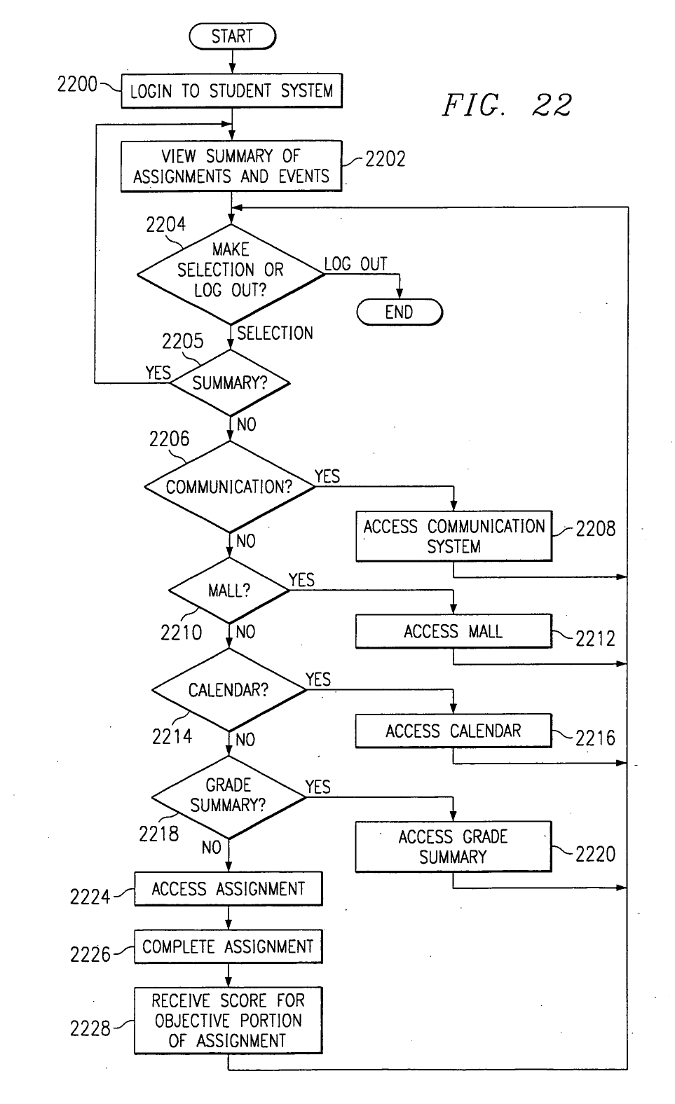

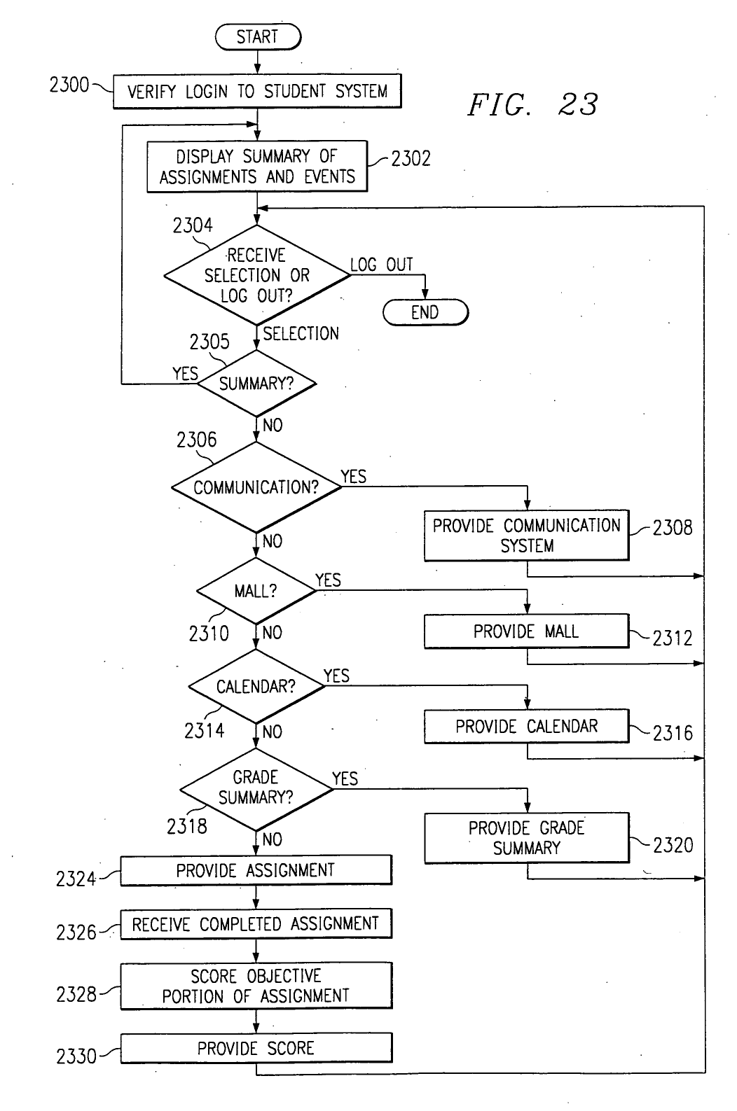

FIG. 22 is a flow diagram illustrating a method for utilizing the student system 56 from the point of view of a user of the system 10 in accordance with one embodiment of the present invention. The method begins at step 2200 where a student logs in to the student system 56. This step may comprise providing user identification, a password and/or other suitable security data. At step 2202, the student views a summary of assignments, such as released learning activities 130, and events. In addition, the student may view information relating to each of his or her courses 74, such as the course name, the teacher's name, the class period in which the student is enrolled in the course 74, the student's overall grade for the course 74, the class average, standards for the course 74, a course description and the like.

At decisional step 2204, the student makes a selection to access a component of the student system 56 or chooses to log out of the system 56. According to one embodiment, the components provided for selection comprise a summary of assignments and events, communication, mall, calendar, grade summary, and assignments. However, it will be understood that the components may comprise any other suitable components without departing from the scope of the present invention.

If the student chooses to log out of the system 56, the method follows the Logout branch from decisional step 2204 and the method comes to an end. However, if the student makes a selection, the method follows the Selection branch from decisional step 2204 to decisional step 2205. At decisional step 2205, a determination is made regarding whether the student selected summary. If the student selected summary, the method follows the Yes branch from decisional step 2205 and returns to step 2202 where the student views a summary of assignments and events. However, if the selection was not summary, the method follows the No branch from decisional step 2205 to decisional step 2206.

At decisional step 2206, a determination is made regarding whether the student selected communication. If the student selected communication, the method follows the Yes branch from decisional step 2206 to step 2208 where the student accesses the communication system. While accessing the communication system, the student may view, send and manage communication between the student and a parent, teacher, another student or the like. According to one embodiment, this communication system comprises e-mail communication. After the student is finished with the communication system, the method returns to decisional step 2204 where another selection may be made or the student may log out of the system 56.

Returning to decisional step 2206, if the selection was not communication, the method follows the No branch from decisional step 2206 to decisional step 2210 where a determination is made regarding whether the selection was mall. If the selection was mall, the method follows the Yes branch from decisional step 2210 to step 2212 where the student accesses a virtual mall of district-approved vendors. After the student has finished accessing the mall, the method returns to decisional step 2204 where the student may make another selection or log out of the system 56.

Returning to decisional step 2210, if the selection was not mall, the method follows the No branch from decisional step 2210 to decisional step 2214 where a determination is made regarding whether the selection was calendar. If the selection was calendar, the method follows the Yes branch from decisional step 2214 to step 2216 where the student accesses the calendar. The calendar may comprise a listing of district, campus, teacher, parent or student defined events. While accessing the calendar, the student may maintain and organize personal, school and family events and activities. According to one embodiment, the student may select a particular day from the calendar in order to view a listing of events and activities for the selected day. After the student has finished with the calendar, the method returns to decisional step 2204 where the student may make another selection or log out of the system 56.

Returning to decisional step 2214, if the selection was not calendar, the method follows the No branch from decisional step 2214 to decisional step 2218 where a determination is made regarding whether the selection was grade summary. If the selection was grade summary, the method follows the Yes branch from decisional step 2218 to step 2220 where the student accesses a grade summary. According to one embodiment, the grade summary is displayed in order based on course 74 and assignment date, due date or other suitable criteria. The grade summary may comprise a title, an assignment type, such as classroom or homework, a released date, a due date, an assignment status, such as outstanding, completed, graded or the like, a grade, and any other suitable information.

While accessing the grade summary, the student may access grades and teacher remarks, if any, for completed assignments. At this point, the student may view the name of the assignment, a description of the assignment, a grade for the assignment, standards for the assignment, procedures 96 for the assignment, responses given by the student, resource links, and the like. In addition, the student may view information relating to each of his or her courses 74, such as the course name, the teacher's name, the class period in which the student is enrolled in the course 74, the student's overall grade for the course 74, the class average, standards for the course 74, a course description and the like. While viewing information for a particular course 74, the student may choose to organize the assignments for that course 74 by due date, assignment type, and the like. After a student is finished viewing the grade summary, the method returns to decisional step 2204 where the student may make another selection or log out of the system 56.

Returning to decisional step 2218, if the selection was not grade summary, the selection was to access an uncompleted or partially completed assignment, and the method follows the No branch from decisional step 2218 to step 2224 where the student accesses a particular assignment. When an assignment is accessed by the student, the system 56 may display the name of the assignment, a description of the assignment, standards for the assignment, procedures 96 for the assignment, resource links, and the like. At this point, the student may complete each of the procedures 96 associated with the assignment. While completing each procedure 96, the student may access system resources for the procedure 96 through procedure links associated with the procedure 96.

At step 2226, the student completes the assignment. For assignments comprising one or more assessments 79, the student submits the assessment 79 for scoring. Alternatively, timed assessments 79 are automatically submitted. At step 2228, the student receives a score for the objective portion of the assignment. Scores for subjective assignments may be made available to the student at a later time. The method then returns to step 2204 where the student may make another selection or log out of the system 56.

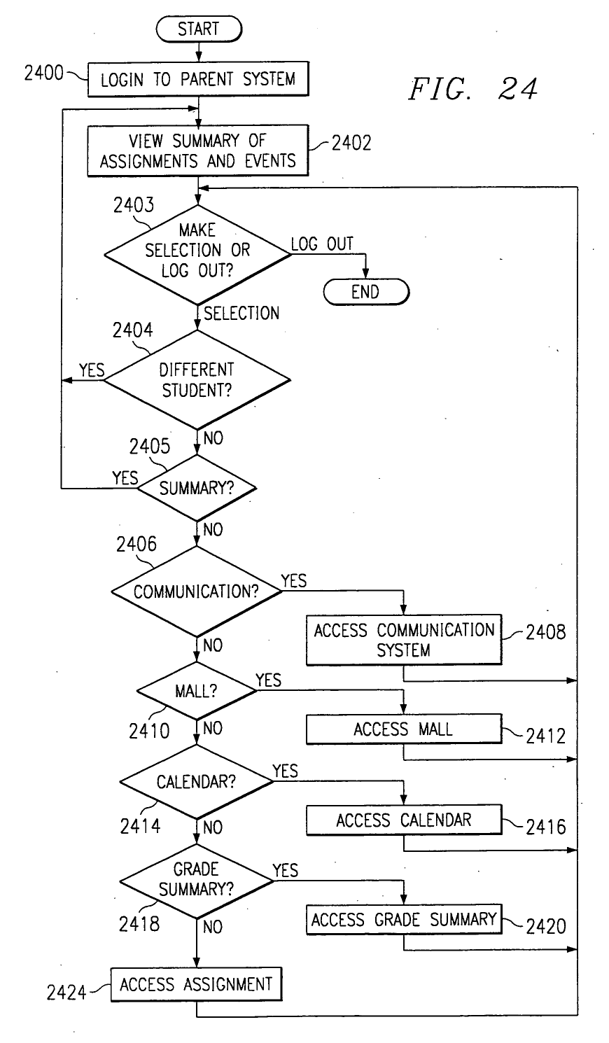

FIG. 23 is a flow diagram illustrating a method for providing the student system 56 from the point of view of the system 10 in accordance with one embodiment of the present invention. The method begins at step 2300 where a student logging in to the student system 56 is verified. This step may comprise receiving user identification, a password and/or other suitable security data for verification. At step 2302, a summary of assignments, such as released learning activities 130, and events is displayed.

At decisional step 2304, a selection is received for access to a component of the student system 56 or for logging out of the system 56. According to one embodiment, the components provided for selection comprise a summary of assignments and events, communication, mall, calendar, grade summary, and assignments. However, it will be understood that the components may comprise any other suitable components without departing from the scope of the present invention.

If a choice is made to log out of the system 56, the method follows the Logout branch from decisional step 2304 and the method comes to an end. However, if a selection of a component is made, the method follows the Selection branch from decisional step 2304 to decisional step 2305. At decisional step 2305, a determination is made regarding whether the selection was summary. If the selection was summary, the method follows the Yes branch from decisional step 2305 and returns to step 2302 where a summary of assignments and events is displayed. However, if the selection was not summary, the method follows the No branch from decisional step 2305 to decisional step 2306.

At decisional step 2306, a determination is made regarding whether the selection was communication. If the selection was communication, the method follows the Yes branch from decisional step 2306 to step 2308 where the communication system is provided. While providing the communication system, the system 10 allows a student to view, send and manage communication between the student and a parent, teacher, another student or the like. According to one embodiment, this communication system comprises e-mail communication. After the student is finished with the communication system, the method returns to decisional step 2304 where another selection may be received or the student may log out of the system 56.

Returning to decisional step 2306, if the selection was not communication, the method follows the No branch from decisional step 2306 to decisional step 2310 where a determination is made regarding whether the selection was mall. If the selection was mall, the method follows the Yes branch from decisional step 2310 to step 2312 where a virtual mall of district-approved vendors is provided to the student. After the student has finished accessing the mall, the method returns to decisional step 2304 where another selection may be received or the student may log out of the system 56.

Returning to decisional step 2310, if the selection was not mall, the method follows the No branch from decisional step 2310 to decisional step 2314 where a determination is made regarding whether the selection was calendar. If the selection was calendar, the method follows the Yes branch from decisional step 2314 to step 2316 where a calendar is provided to the student. The calendar may comprise a listing of district, campus, teacher, parent or student defined events. While providing the calendar, the system 10 may allow the student to maintain and organize personal, school and family events and activities. According to one embodiment, a selection may be received for a particular day from the calendar, causing a listing of events and activities for the selected day to be displayed. After the student has finished with the calendar, the method returns to decisional step 2304 where another selection may be received or the student may log out of the system 56.

Returning to decisional step 2314, if the selection was not calendar, the method follows the No branch from decisional step 2314 to decisional step 2318 where a determination is made regarding whether the selection was grade summary. If the selection was grade summary, the method follows the Yes branch from decisional step 2318 to step 2320 where the grade summary is provided to the student. According to one embodiment, the grade summary is displayed in order based on course 74 and assignment date, due date or other suitable criteria. The grade summary may comprise a title, an assignment type, such as classroom or homework, a released date, a due date, an assignment status, such as outstanding, completed, graded or the like, a grade and any other suitable information.

While providing the grade summary, the system 10 may allow the student to access grades and teacher remarks, if any, for completed assignments. At this point, the student may view the name of the assignment, a description of the assignment, a grade for the assignment, standards for the assignment, procedures 96 for the assignment, responses given by the student, resource links, and the like. In addition, the system 10 may provide the student with information relating to each of his or her courses 74, such as the course name, the teacher's name, the class period in which the student is enrolled in the course 74, the student's overall grade for the course 74, the class average, standards for the course 74, a course description and the like. While viewing information for a particular course 74, the student may choose to organize the assignments for that course 74 by due date, assignment type, and the like. After a student is finished viewing the grade summary, the method returns to decisional step 2304 where another selection is received or the student may log out of the system 56.

Returning to decisional step 2318, if the selection was not grade summary, the selection was to access an uncompleted or partially completed assignment, and the method follows the No branch from decisional step 2318 to step 2324 where access to a particular assignment is provided to the student. When access to an assignment is provided to the student, the system 56 may display the name of the assignment, a description of the assignment, standards for the assignment, procedures 96 for the assignment, resource links, and the like. At this point, the student may complete each of the procedures 96 associated with the assignment. While completing each procedure 96, the student may access system resources for the procedure 96 through procedure links associated with the procedure 96.

At step 2326, the completed assignment is received from the student. For assignments comprising one or more assessments 79, the assessments 79 are received for scoring. At step 2328, any objective portions of the assessments 79 are scored. At step 2330, a score for the objective portion of an assessment 79 is provided to the student. Scores for subjective assignments may be provided to the student at a later time. The method then returns to step 2304 where another selection is received or the student logs out of the system 56.

FIG. 24 is a flow diagram illustrating a method for utilizing the parent system 58 from the point of view of a user of the system 10 in accordance with one embodiment of the present invention. The method begins at step 2400 where a parent logs in to the parent system 58. This step may comprise providing user identification, a password and/or other suitable security data. At step 2402, the parent views a summary of assignments, such as released learning activities 130, and events for one of their children. The child whose summary is displayed may be determined alphabetically, by age, or by any other suitable attribute.

At decisional step 2403, the parent makes a selection to access a component of the parent system 58 or chooses to log out of the system 58. According to one embodiment, the components provided for selection comprise a different child, summary of assignments and events, communication, mall, calendar, grade summary, and assignments. However, it will be understood that the components may comprise any other suitable components without departing from the scope of the present invention.

If the parent chooses to log out of the system 58, the method follows the Logout branch from decisional step 2403 and the method comes to an end. However, if the parent makes a selection, the method follows the Selection branch from decisional step 2403 to decisional step 2404.

At decisional step 2404, a determination is made regarding whether the parent has selected a different student other than the one whose summary was originally displayed. If the parent has selected a different student, the method follows the Yes branch from decisional step 2404 and returns to step 2402 where the parent views a summary of assignments and events for the selected student. However, if the parent has not selected a different student, the method follows the No branch from decisional step 2404 to decisional step 2405.

At decisional step 2405, a determination is made regarding whether the parent selected summary. If the parent selected summary, the method follows the Yes branch from decisional step 2405 and returns to step 2402 where the parent views a summary of assignments and events for the currently selected child. However, if the selection was not summary, the method follows the No branch from decisional step 2405 to decisional step 2406.

At decisional step 2406, a determination is made regarding whether the parent selected communication. If the parent selected communication, the method follows the Yes branch from decisional step 2406 to step 2408 where the parent accesses the communication system. While accessing the communication system, the parent may view, send and manage communication between the parent and a teacher, student or the like. According to one embodiment, this communication system comprises e-mail communication. After the parent is finished with the communication system, the method returns to decisional step 2403 where another selection may be made or the parent may log out of the system 58.

Returning to decisional step 2406, if the selection was not communication, the method follows the No branch from decisional step 2406 to decisional step 2410 where a determination is made regarding whether the selection was mall. If the selection was mall, the method follows the Yes branch from decisional step 2410 to step 2412 where the parent accesses a virtual mall of district-approved vendors. After the parent has finished accessing the mall, the method returns to decisional step 2403 where the parent may make another selection or log out of the system 58.

Returning to decisional step 2410, if the selection was not mall, the method follows the No branch from decisional step 2410 to decisional step 2414 where a determination is made regarding whether the selection was calendar. If the selection was calendar, the method follows the Yes branch from decisional step 2414 to step 2416 where the parent accesses the calendar. The calendar may comprise a listing of district, campus, teacher, parent or student defined events. While accessing the calendar, the parent may maintain and organize personal, school and family events and activities. According to one embodiment, the parent may select a particular day from the calendar in order to view a listing of events and activities for the selected day. After the parent has finished with the calendar, the method returns to decisional step 2403 where the parent may make another selection or log out of the system 58.

Returning to decisional step 2414, if the selection was not calendar, the method follows the No branch from decisional step 2414 to decisional step 2418 where a determination is made regarding whether the selection was grade summary. If the selection was grade summary, the method follows the Yes branch from decisional step 2418 to step 2420 where the parent accesses a grade summary for the currently selected child. According to one embodiment, the grade summary is displayed in order based on course 74 and assignment date, due date or other suitable criteria. The grade summary may comprise a title, an assignment type, such as classroom or homework, a released date, a due date, an assignment status, such as outstanding, completed, graded or the like, a grade and any other suitable information.

While accessing grade summary, the parent may access grades and teacher remarks, if any, for assignments that have been completed by the currently selected child. At this point, the parent may view the name of the assignment, a description of the assignment, a grade for the assignment, standards for the assignment, procedures 96 for the assignment, responses given by the student, resource links, and the like. After a parent is finished viewing the grade summary, the method returns to decisional step 2403 where the parent may make another selection or log out of the system 58.

Returning to decisional step 2418, if the selection was not grade summary, the selection was to access an uncompleted or partially completed assignment, and the method follows the No branch from decisional step 2418 to step 2424. At step 2424, the parent accesses a particular uncompleted or partially completed assignment. When an assignment is accessed by the parent, the system 58 may display the name of the assignment, a description of the assignment, standards for the assignment, procedures 96 for the assignment, resource links, and the like. At this point, the parent may view each of the procedures 96 associated with the assignment. In addition, if the student has partially completed the assignment, the parent may view the responses given by the student as well as the partial grade for the assignment. After the parent is finished accessing the assignment, the method returns to decisional step 2403 where the parent may make another selection or log out of the system 58.

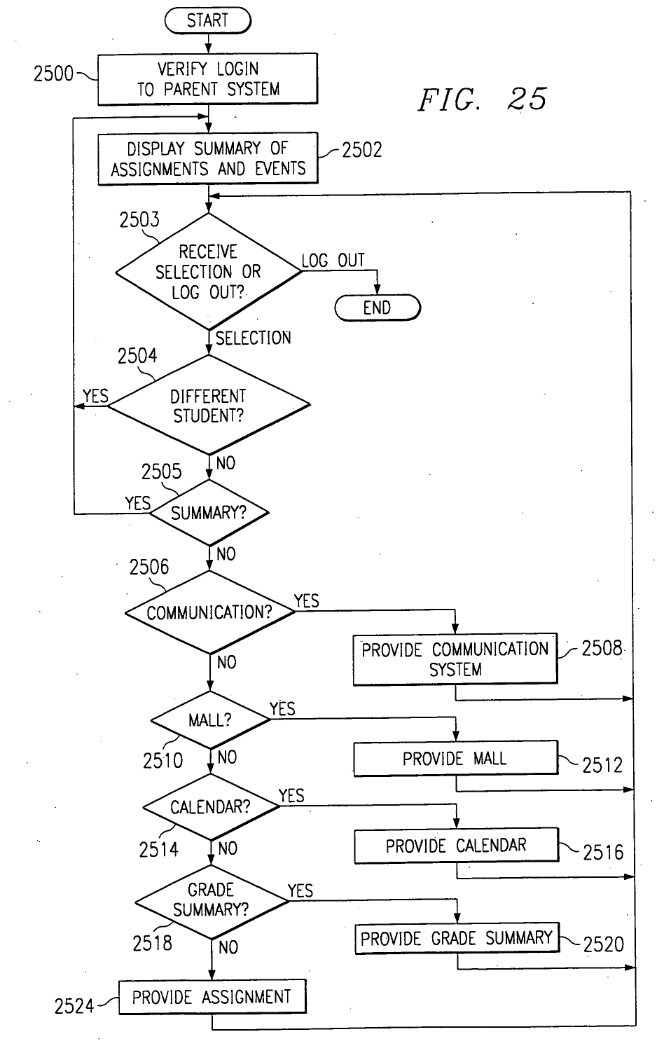

FIG. 25 is a flow diagram illustrating a method for providing the parent system 58 from the point of view of the system 10 in accordance with one embodiment of the present invention. The method begins at step 2500 where a parent logging in to the parent system 58 is verified. This step may comprise receiving user identification, a password and/or other suitable security data for verification. At step 2502, a summary of assignments, such as released learning activities 130, and events is displayed for one of the parent's children. The child whose summary is displayed may be determined alphabetically, by age, or by any other suitable attribute.

At decisional step 2503, a selection is received for access to a component of the parent system 58 or for logging out of the system 58. According to one embodiment, the components provided for selection comprise a different child, summary of assignments and events, communication, mall, calendar, grade summary, and assignments. However, it will be understood that the components may comprise any other suitable components without departing from the scope of the present invention.

If a choice is made to log out of the system 58, the method follows the Logout branch from decisional step 2503 and the method comes to an end. However, if a selection of a component is made, the method follows the Selection branch from decisional step 2503 to decisional step 2504.

At decisional step 2504, a determination is made regarding whether a selection has been received of a different student other than the one whose summary was originally displayed. If a selection has been received of a different student, the method follows the Yes branch from decisional step 2504 and returns to step 2502 where a summary of assignments and events for the selected student is displayed. However, if a selection of a different student has not been received, the method follows the No branch from decisional step 2504 to decisional step 2505.

At decisional step 2505, a determination is made regarding whether the selection was summary. If the selection was summary, the method follows the Yes branch from decisional step 2505 and returns to step 2502 where a summary of assignments and events for the currently selected child is displayed. However, if the selection was not summary, the method follows the No branch from decisional step 2505 to decisional step 2506.

At decisional step 2506, a determination is made regarding whether the selection was communication. If the selection was communication, the method follows the Yes branch from decisional step 2506 to step 2508 where the communication system is provided. While providing the communication system, the system 10 allows a parent to view, send and manage communication between the parent and a teacher, student or the like. According to one embodiment, this communication system comprises e-mail communication. After the parent is finished with the communication system, the method returns to decisional step 2503 where another selection may be received or the parent may log out of the system 58.

Returning to decisional step 2506, if the selection was not communication, the method follows the No branch from decisional step 2506 to decisional step 2510 where a determination is made regarding whether the selection was mall. If the selection was mall, the method follows the Yes branch from decisional step 2510 to step 2512 where a virtual mall of district-approved vendors is provided to the parent. After the parent has finished accessing the mall, the method returns to decisional step 2503 where another selection may be received or the parent may log out of the system 58.

Returning to decisional step 2510, if the selection was not mall, the method follows the No branch from decisional step 2510 to decisional step 2514 where a determination is made regarding whether the selection was calendar. If the selection was calendar, the method follows the Yes branch from decisional step 2514 to step 2516 where a calendar is provided to the parent. The calendar may comprise a listing of district, campus, teacher, parent or student defined events. While providing the calendar, the system 10 may allow the parent to maintain and organize personal, school and family events and activities. According to one embodiment, a selection may be received for a particular day from the calendar, causing a listing of events and activities for the selected day to be displayed. After the parent has finished with the calendar, the method returns to decisional step 2503 where another selection may be received or the parent may log out of the system 58.

Returning to decisional step 2514, if the selection was not calendar, the method follows the No branch from decisional step 2514 to decisional step 2518 where a determination is made regarding whether the selection was grade summary. If the selection was grade summary, the method follows the Yes branch from decisional step 2518 to step 2520 where the grade summary for the currently selected child is provided to the parent. According to one embodiment, the grade summary is displayed in order based on course 74 and assignment date, due date or other suitable criteria. The grade summary may comprise a title, an assignment type, such as classroom or homework, a released date, a due date, an assignment status, such as outstanding, completed, graded or the like, a grade and any other suitable information.

While providing the grade summary, the system 10 may allow the parent to access grades and teacher remarks, if any, for assignments that have been completed by the currently selected child. At this point, the parent may view the name of the assignment, a description of the assignment, a grade for the assignment, standards for the assignment, procedures 96 for the assignment, responses given by the student, resource links, and the like. After a parent is finished viewing the grade summary, the method returns to decisional step 2503 where another selection is received or the parent may log out of the system 58.

Returning to decisional step 2518, if the selection was not grade summary, the selection was to access an uncompleted or partially completed assignment, and the method follows the No branch from decisional step 2518 to step 2524. At step 2524, access to a particular uncompleted or partially completed assignment is provided to the parent. When access to an assignment is provided to the parent, the system 58 may display the name of the assignment, a description of the assignment, standards for the assignment, procedures 96 for the assignment, resource links, and the like. At this point, the parent may view each of the procedures 96 associated with the assignment. In addition, if the student has partially completed the assignment, the system 58 may display the responses given by the student as well as the partial grade for the assignment. After the parent is finished accessing the assignment, the method returns to decisional step 2503 where another selection is received or the parent logs out of the system 58.

FIG. 26 is a flow diagram illustrating a method for transferring data displayed on one of the access devices 34 from a source window to a destination window in accordance with one embodiment of the present invention. The source window and the destination window each comprise a DOM compatible web browser window capable of displaying HTML. The source window may be distinct from the destination window. Alternatively, the source window and the destination window may be a same window within which data is to be transferred.

The method begins at step 2600 where data is selected to be transferred, or dragged, from the source window. According to one embodiment, the data is selected by clicking on an icon associated with the data. However, it will be understood that the data may be selected in any other suitable manner without departing from the scope of the present invention.

At step 2602, an event handler embedded in the source window captures a drag event in the source window. The drag event may comprise, for example, an ‘ondragstart’ event for a Microsoft Internet Explorer source window, a combination of an ‘onmousedown’ event and an ‘onmousemove’ event for a Netscape/Mozilla source window, or other suitable event or combination of events associated with the beginning of a drag.

At step 2604, the event handler in the source window packages the selected data into a data structure. According to one embodiment, the data structure comprises a character string. At step 2606, the event handler in the source window stores the packaged data, along with the origination of the data. This data may be stored in a global array or other suitable data store.

At step 2608, an event handler embedded in the destination window captures a drop event in the destination window. The drop event may comprise, for example, an ‘ondrop’ event for a Microsoft Internet Explorer destination window, an ‘ondragdrop’ event for a Netscape/Mozilla destination window, or other suitable event or combination of events associated with a drop.

At step 2610, the event handler in the destination window queries the source window for the data store. At step 2612, the event handler in the destination window attempts to validate the stored data. For example, the event handler in the destination window may parse the stored data structure for the necessary data and attempt to validate that data against the current data on the page.

At decisional step 2614, a determination is made regarding whether the stored data was validated. If the stored data was validated, the method follows the Yes branch from decisional step 2614 to step 2616. At step 2616, the event handler in the destination window transfers, or drops, the stored data into the destination window, after which the method comes to an end. However, if the stored data was not validated, the method follows the No branch from decisional step 2614 and comes to an end without dropping the stored data into the destination window. In this way, data may be transferred within a browser window or from one browser window to another using a drag-and-drop method in a variety of situations.

For example, teach topics 92 and skill objectives 94 may be dragged and dropped onto learning activities 76 in order to associate the teach topics 92 and skill objectives 94 with learning activities 76. Teach topics 92 and skill objectives 94 may be dragged and dropped onto the time matrix 90 in order to create or modify a course matrix 86. Teach topics 92 and skill objectives 94 may be dragged and dropped onto questions 78 in order to associate the teach topics 92 and skill objectives 94 with questions 78.

Questions 78 may be dragged and dropped onto question-based assessments 100 to be included in the question-based assessments 100. For questions 78 with a question type of matching, a student may drag and drop selections from one category onto selections in the other category in order to match the corresponding elements in the two categories.

Learning activities 76 may be selected for the lesson plan 120 by dragging and dropping the learning activities 76 onto the lesson plan 120. In scheduling learning activities 124, the selection of a date or school day for the learning activity 124 may be made by dragging and dropping the learning activity 124 onto the selected day displayed on a calendar. Also, the learning activity 124 may be dragged from one day on the schedule 126 and dropped at another day on the schedule 126 to re-schedule the learning activity 124 or may be dragged and dropped off the schedule 126 to un-schedule the learning activity 124. Learning activities 124 may be released to students by dragging and dropping the learning activities 124 onto the list of students. Students previously selected to receive the learning activity 124 would then have access to the released activity 130.

It will be understood that any suitable selections within the system 10 may be made via drag-and-drop selections without departing from the scope of the present invention. According to one embodiment, data which may be dragged and dropped is indicated by an associated icon such that a user may drag and drop the icon in order to select and transfer the data from one location to another.

Although the present invention has been described with several embodiments, various changes and modifications may be suggested to one skilled in the art. It is intended that the present invention encompass such changes and modifications as fall within the scope of the appended claims.

1. A method for generating a lesson plan for a course, comprising:
associating a plurality of standard objectives with the course;
providing a plurality of learning activities for selection, each learning activity associated with at least one standard objective for the course;
receiving a selection of at least a subset of the learning activities; and
generating the lesson plan based on the selected learning activities.

2.-79. (canceled)
